(19) United States
(12) Patent Application Publication
(10) Pub. No.: US 2020/0160637 A1
(43) Pub. Date: May 21, 2020

(54) STORAGE APPARATUS

(71) Applicant: SHUHEI HARA, Tokyo (JP)

(72) Inventor: SHUHEI HARA, Tokyo (JP)

(21) Appl. No.: 16/195,601

(22) Filed: Nov. 19, 2018

(51) Int. Cl. G07C 9/00; G08B 21/24; G08B 5/22

(52) U.S. Cl. CPC G07C 9/00896; G07C 9/00142; G08B 5/22; G08B 21/24; G07C 9/00158

(57) ABSTRACT

A storage apparatus is provided, which prevents a user, who intends to retrieve articles, such as deliveries, simultaneously from a plurality of storage boxes making up the storage apparatus, from forgetting to retrieve an article from one storage box and allows the user to retrieve an article from each of the storage boxes easily and safely. A storage system includes a storage apparatus that stores an article addressed to a user in a storage box and keeps the article temporarily in the storage box having been locked, a management server that manages the storage status of the article stored in the storage apparatus, a user terminal that is an information processing device operated by the user, and authentication media and having recorded thereon authentication information used for unlocking the storage box of the storage apparatus.

### STATEMENT REGARDING PRIOR DISCLOSURE BY THE INVENTOR

Japanese Publication No. 2017-218780 dated Dec. 14, 2017 and Japanese Publication No. 2017-205288 dated Nov. 24, 2017 are grace period inventor-originated disclosures which qualify as exceptions under 35 USC § 102(b)(1).

### TECHNICAL FIELD

The present invention relates to a storage apparatus and particularly to a storage apparatus that stores a user's articles in a plurality of storage boxes, respectively, to keep the articles temporarily in storage.

### BACKGROUND ART

In recent years, nuclear families, unmarried people, people who marries late in life, and people living alone have been increasing in number in today's society with an aging population resulting from a low-birth rate. The number of dual-career households is increasing as well, causing a significant change in people's lifestyles.

Thriving electronic commerce in these days has lead to a number of cases where articles, such as purchased goods, are delivered to individual households. Meanwhile, the growing number of dual-career households, as mentioned above, has resulted in an increase in people absent from their homes. Under these circumstances, an environment, equipment, etc., that allows people to smoothly receive such delivered articles is in demand.

To meet such a demand, recently, a delivery storage apparatus, which is referred to as home-delivery locker, is installed in common areas of condominiums, such as apartment houses, in many cases.

This delivery storage apparatus has a plurality of storage boxes that can be used in common by residents, and articles addressed to a resident of a condominium, i.e., deliveries to a resident are stored temporarily in the boxes in which the deliveries are kept safe by locking the boxes. Even if the resident is absent from his or her home at delivery of the articles, therefore, the resident has no need to make a redelivery request but is able to take the deliveries to the resident out of the boxes, thus being able to receive the deliveries smoothly.

In addition to such a delivery storage apparatus, a mail storage apparatus is also installed in a common area, etc., of a condominium.

Different from the above delivery storage apparatus, the mail storage apparatus has storage boxes each serving as a dedicated mailbox allocated to each dwelling unit. These dedicated mailboxes are usually locked, and the residents of other dwelling units cannot unlock the mailboxes.

As one of conventional techniques concerning the above storage apparatus that is installed in a common area, etc., of a condominium and stores both deliveries and mails, a delivery receiving system disclosed in patent document 1 has been proposed.

The delivery receiving system disclosed in patent document 1 includes a box apparatus. This box apparatus is installed in a common area of a condominium, and has home-delivery boxes in which deliveries to residents are stored temporarily and mailboxes in which mails, etc., are stored temporarily.

The box apparatus according to patent document 1 is configured such that when a delivery person carrying a delivery stores the delivery in the box apparatus, the delivery person is prompted to unlock a home-delivery box located close to a mailbox allocated to a dwelling unit to which the delivery is addressed and to store the delivery in the home-delivery box.

When a resident takes out a mail from a mailbox in the box apparatus, therefore, the resident is able to take out also a delivery from a home-delivery box located close to the mailbox.

### PATENT DOCUMENT

[Patent Document 1] Japanese Unexamined Patent Application Publication No. 2009-273934

### SUMMARY

### Problem to be Solved

As described above, the delivery receiving system disclosed in patent document 1 prompts a delivery person to store a delivery in a home-delivery box located close to a mailbox allocated to a dwelling unit to which the delivery is addressed.

However, according to the system disclosed in patent document 1, when the home-delivery box located close to the mail box is used at the time of storage of the delivery, the delivery person has no option but to store the delivery in a home-delivery box distant from the mailbox.

In such a case, simultaneously unlocking and opening the mailbox and the home-delivery box distant from each other leads to a problem that the resident takes a delivery out of one box but forgets to retrieve a delivery from the other box, or that the delivery in the other box is stolen as the resident takes the delivery out of one box.

The present invention was conceived in view of the above problem, and it is therefore an object of the invention to provide a storage apparatus that when a user simultaneously retrieves articles, such as deliveries, from a plurality of storage boxes making up the storage apparatus, prevents the user from forgetting to retrieve an article from one storage box and allows the user to retrieve each of the articles easily and safely from each of the storage boxes.

### Means for Solving the Problem

In order to solve the above problem, the present invention provides a storage apparatus having a plurality of lockable storage boxes for storing articles. The storage apparatus includes: a control unit that executes an authentication process for unlocking storage boxes; and the storage boxes including a mailbox serving as a dedicated storage box allocated to a user or the user's group, the mailbox having a throw-in port that is an opening through which an article, such as a mail, can be thrown in, and storing an article having been thrown into the mailbox through the throw-in port, a dedicated box serving as a dedicated storage box allocated to a user or the user's group, the dedicated box storing a delivery, etc., and a common use box serving as a storage box that can be used in common by a user or the user's group and by others as well, the common use box storing a delivery, etc.

According to the present invention, when common authentication information assigned to a user is entered, the control unit unlocks the mailbox, the dedicated box, and the common use box in which an article addressed to the user or to another user not included in the user' group is stored.

According to the present invention, in a case where an article address to a user or to another user not included in the user's group is stored in the dedicated box, the control unit unlocks the dedicated box and the mailbox as well when authentication information is entered.

According to the present invention, the storage apparatus further includes a display unit that displays information. In a case where an article address to a user or to another user not included in the user's group is stored in the common use box, the control unit unlocks the mail box when authentication information is entered, and after the mailbox is locked, displays the presence of the common use box in which the article addressed to the user or to another user not included in the user's group is stored and prompts retrieval of the article.

According to the present invention, a storage apparatus has a plurality of lockable storage boxes for storing articles. In the storage apparatus, the storage boxes include: a mailbox serving as a dedicated storage box allocated to a user or the user's group, the mail box having a throw-in port that is an opening through which an article, such as a mail, can be thrown in, and storing an article having been thrown into the mail box through the throw-in port; and a dedicated box serving as a dedicated storage box allocated to a user or the user's group, the dedicated box storing a delivery, etc. In the storage apparatus, the mailbox and the dedicated box are located adjacent or close to each other.

According to the present invention, a storage apparatus has a lockable storage box that stores an article, and the storage box can be unlocked by entering given authentication information. The storage box is a dedicated box allocated to a specific user or a specific group made up of a plurality of users. Setting on unlocking of the dedicated box is made to determine whether the dedicated box can be unlocked with only the authentication information on the specific user or with the authentication information on the specific user as well as authentication information on a worker who stores or retrieves the user's article, thereby determine use of the dedicated box.

According to the present invention, when authentication information identical with authentication information on a user allowed to unlock the dedicated box is entered, setting authentication information with which the dedicated box can be unlocked is allowed.

According to the present invention, when unlocking of the dedicated box is set such that the dedicated box can be unlocked with authentication information on the user as well as authentication information on the worker, the dedicated box is used as a home-delivery box that temporarily keeps a delivery addressed to the user or a delivery stored in the dedicated box by the user.

According to the present invention, when unlocking of the storage box is set such that the storage box can be unlocked only with the authentication information on the user, the storage box is used as a trunk box that keeps an article stored therein by the user.

According to the present invention, the storage boxes include a dedicated box allocated to the specific user and a common use box used in common by a plurality of users. When setting is made on the dedicated box allocated to the specific user such that the dedicated box can be unlocked only with the authentication information on the user, a worker is prompted to store a delivery in the common use box.

Any given combination of the above constituent elements and constituent elements or expressions of the present invention that are subjected to mutual substitution in terms of methods, devices, systems, computer programs, recording devices storing computer programs, and the like are also effective as aspects of the present invention.

### Advantageous Effects

The present invention provides the storage apparatus having the plurality of lockable storage boxes for storing articles, and this storage apparatus includes the dedicated mailbox that stores mails, etc., and the common use box that stores deliveries, etc., and that can be used in common by users, and further includes the dedicated box used exclusively to store deliveries, etc., addressed to users. The dedicated box can be located very close to the mailbox. As a result, when a user simultaneously retrieves articles, such as deliveries, from a plurality of storage boxes making up the storage apparatus, the storage apparatus prevents the user from forgetting to retrieve an article from one storage box and allows the user to retrieve each of the articles easily and safely from each of the storage boxes.

### BRIEF DESCRIPTION OF THE DRAWINGS

FIG. 1 is a diagram showing a configuration of a storage system according to a first embodiment of the present invention;

FIG. 2 is an external view of the front side of a storage apparatus according to the first embodiment of the present invention;

FIG. 3 is a diagram showing a configuration of the storage apparatus according to the first embodiment of the present invention;

FIG. 4 is an external view of the front side of a dedicated box or common use box according to the first embodiment of the present invention;

FIG. 5 is a diagram showing databases included in an information storage unit of the storage apparatus according to the first embodiment of the present invention;

FIG. 6 is a diagram showing an example of a data configuration of a user DB according to the first embodiment of the present invention;

FIG. 7 is a diagram showing an example of a data configuration of a storage box DB according to the first embodiment of the present invention;

FIG. 8 is a diagram showing an example of a data configuration of a worker DB 123 according to the first embodiment of the present invention;

FIG. 9 is a diagram showing a configuration of a management server according to the first embodiment of the present invention;

FIG. 10 is a diagram showing databases included in an information storage unit of the management server according to the first embodiment of the present invention;

FIG. 11 is a diagram showing a configuration of a user terminal according to the first embodiment of the present invention;

FIG. 12 is a flowchart of a flow of operations that are carried out by the storage apparatus when a worker from a shipping carrier, etc., stores an article in the storage apparatus, according to the first embodiment of the present invention;

FIG. 13 is a flowchart of a flow of operations that are carried out by the storage apparatus when a user retrieves an article from the storage apparatus, according to the first embodiment of the present invention;

FIG. 14 is a flowchart of a flow of operations that are carried out by the storage apparatus when a user retrieves an article from the storage apparatus, according to the first embodiment of the present invention;

FIG. 15 is a diagram showing an example of a data configuration of the storage box DB according to a second embodiment of the present invention;

FIG. 16 is a flowchart of a flow of operations that are carried out by the storage apparatus when setting is made on unlocking of the dedicated box, according to the second embodiment of the present invention;

FIG. 17 is a flowchart of a flow of operations that are carried out by the storage apparatus when setting is made for locking of the dedicated box, according to the second embodiment of the present invention;

FIG. 18 is a diagram showing an example of on-screen information for determining whether or not to allow a worker to store a delivery, according to the second embodiment of the present invention;

FIG. 19 is a flowchart of a flow of operations that are carried out by the storage apparatus when a worker from a shipping carrier, etc., stores an article in the storage apparatus, according to the second embodiment of the present invention;

FIG. 20 is a flowchart of a flow of operations that are carried out by the storage apparatus when a user retrieves an article from the storage apparatus, according to the second embodiment of the present invention; and

FIG. 21 is a flowchart of a flow of operations that are carried out by the storage apparatus when a user retrieves an article from the storage apparatus, according to the second embodiment of the present invention.

### DETAILED DESCRIPTION

### First Embodiment

### (Outline of First Embodiment)

A storage system according to a first embodiment of the present invention can be applied to all kinds of facilities which users reside in or use (which will hereinafter be referred to as “residential/use facilities”).

Residential/use facilities include, for example, condominiums, such as apartment houses, in which users reside, office buildings in which users work, and other commercial facilities (stores/shops) and public facilities.

When an article, such as a delivery and mail, addressed to a user is delivered to such a residential/use facility, a storage apparatus of the storage system stores the article and keeps it temporarily.

The storage apparatus includes a plurality of storage boxes that are used as different boxes according to the types of articles stored therein or to the purposes of use including dedicated use and common use.

The storage system then sends article storage information indicating that the system keeps the article, to a device on which the user can confirm the information. After confirming the details of the information, the user visits a location where the storage apparatus is installed, enters authentication information in the storage apparatus, and retrieves the article addressed to the user from one of the storage boxes of the storage apparatus.

An individual ownership space is a space used exclusively by a user in a residential/use facility, such as the user's dwelling unit in a condominium and an office in an office building.

A common area is a space other than such individual ownership spaces and can be used in common by a number of users who reside in or use the residential/use facility. For example, the entrance is used as a common area.

Hereinafter, description of this embodiment will be made on the assumption that, for example, the residential/use facility is a condominium, such as an apartment house, the individual ownership space is each dwelling unit, the common area is the entrance, and the user is a resident in the condominium.

According to this embodiment, “mails” are articles delivered by workers from shipping carriers including a postal office (USPS). Mails are so limited in size that they can be thrown into a mailbox 161, which will be described later, through a throw-in port of the mailbox 161. For example, mails include postal cards, letters, and small parcels.

When a worker drops a mail into the mailbox 161, the worker does not need to be authenticated.

According to this embodiment, “deliveries” are articles delivered by workers from shipping carriers. Deliveries include postal cards, letters, small parcels, handbills, and newspapers that can be thrown into the throw in port of the mailbox 161 and also include articles that are too large to be thrown into the throw-in port of the mailbox 161.

When a worker unlocks storage boxes 162 and 163 and opens their doors to store a delivery in a dedicated box 162 or common use box 163, which will be described later, the worker need to be authenticated.

### (Configuration of First Embodiment)

### [1] Overall Configuration of Storage System

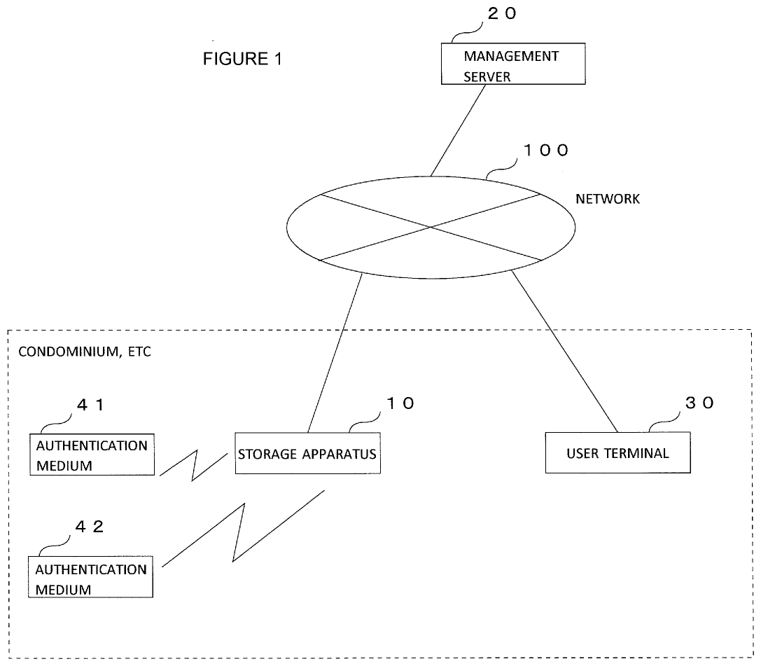

FIG. 1 is a diagram showing a configuration of a storage system according to a first embodiment of the present invention.

As shown in FIG. 1, the storage system includes a storage apparatus 10 that stores an article addressed to a user in a storage box and keeps the article temporarily in the storage box having been locked, a management server 20 that manages the storage status of the article stored in the storage apparatus 10, a user terminal 30 that is an information processing device operated by the user, authentication media 41 and 42 having recorded thereon authentication information used for unlocking the storage box of the storage apparatus 10, and a network 100, such as the Internet and a LAN, that interconnects the storage apparatus 10, the management server 20, and the user terminal to allow them to communicate with each other.

### [2] Configuration of Storage Apparatus 10

### (1) Outline of Storage Apparatus 10

The storage apparatus 10 is a storage apparatus that temporarily stores and keeps an article addressed to a user until the article is retrieved by the user. The storage apparatus 10 includes a plurality of lockable storage boxes.

According to this embodiment, the storage apparatus 10 has a function of reading payment code information displayed on the user terminal 30 and transmitting the read payment code information to the management server 20 through the network 100.

The storage apparatus 10 is installed in condominiums, such as apartment houses, and may also be installed in offices, stores/shops or commercial facilities, such as convenience stores and supermarkets, and public facilities or institutions, such as stations and hospitals. The location of installation of the storage apparatus 10 is not limited to these facilities.

The storage apparatus 10 can store and keep all sorts of articles including deliveries.

For example, the storage apparatus 10 temporarily keeps a delivery that the user wants it to be delivered to a third party until a shipping carrier comes and receives the delivery to deliver it to the third party.

In another case, the shipping carrier stores a delivery to the user temporarily in the storage apparatus 10 until the user retrieves the delivery.

The user can use the storage apparatus 10 to use a dry cleaning service.

The user stores laundry, such as the user's clothes to be cleaned, in the storage apparatus 10. A worker from a dry-cleaning shop retrieves the stored clothes and dry-cleans them. The worker then stores the dry-cleaned clothes in the storage apparatus 10, after which the user takes the cleaned clothes out of the storage apparatus 10.

The user may use the storage apparatus 10 also to receive a food delivery service provided by a supermarket, convenience store, etc.

A delivery person from a food delivery service firm delivers a food ordered by the user and stores the food in the storage apparatus 10, after which the user takes the food out of the storage apparatus 10.

The user may use the storage apparatus 10 also to use an equipment rental or sharing service.

The storage apparatus 10 stores therein, for example, rental equipment such as a cart, a tire inflator, and a key for a mowing machine, meeting room, etc., or a key for such a sharing vehicle as a share car and share bicycle.

The user retrieves the equipment stored in the storage apparatus 10 and after using the equipment, stores it in the storage apparatus 10 to return it to the rental shop, etc.

As an example of equipment renting, the storage apparatus 10 may be used to use a rent-a-car service in the following manner.

When the user asks a rent-a-car firm to rent a car, an employee, etc., of the rent-a-car firm delivers a car to a specified parking lot and stores the key for the car in the storage apparatus 10.

The user takes the key out of the storage apparatus 10, uses the key to drive the car, and after using the car, stores the key in the storage apparatus 10.

Afterward, the employee, etc., of the rent-a-car firm retrieves the key stored in the storage apparatus 10, and drives the car with the key attached thereto, back to an office of the rent-a-car firm.

In the above manner, the storage apparatus 10 can offer the user various services.

### (2) Overall Configuration of Storage Apparatus 10

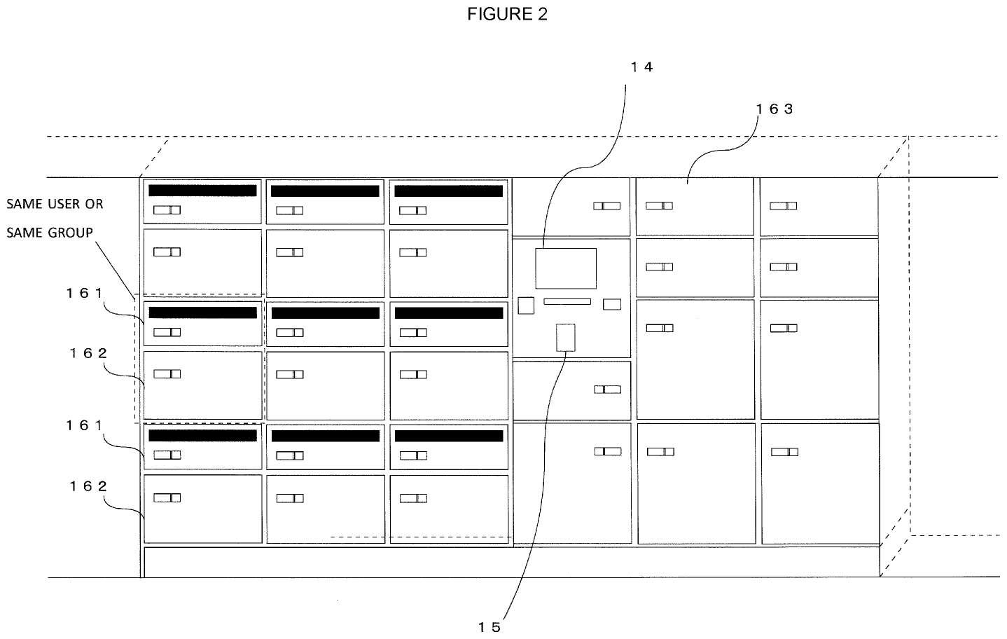

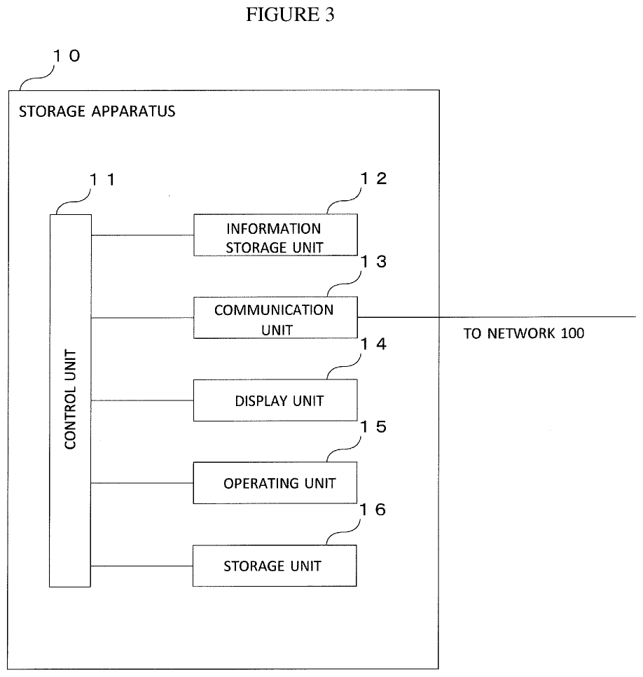

FIG. 2 is an external view of the front side of the storage apparatus 10 according to the first embodiment of the present invention, and FIG. 3 is a diagram showing a configuration of the storage apparatus 10 according to the first embodiment of the present invention.

Hereinafter, a configuration of the storage apparatus 10 will be described, referring to FIGS. 2 and 3.

As shown in FIGS. 2 and 3, the storage apparatus 10 includes a control unit 11 composed of a CPU or the like, the control unit 11 performing overall control over the storage apparatus 10, an information storage unit 12 storing various pieces of information, a communication unit 13 that communicates with the management server 20 through the network 100, a display unit 14 that displays various pieces of information, an information input unit 15 that has various keys to allow information input and that reads authentication information for unlocking a storage box, and a storage unit 16 having a plurality of storage boxes in which articles are stored.

These units 11 to 16 are connected to an internal bus, through which various pieces of information, etc., are input and output to execute various processes under control by the control unit 11.

### (2) Configuration of Storage Unit 16

The storage unit 16 is made up of the plurality of storage boxes.

The storage boxes are storage boxes for temporarily keeping deliveries, mails, etc., addressed to the user, and are configured such that each storage box can be locked and unlocked.

For example, when the user is not at home, a delivery person stores a delivery, etc., to the user in the storage box and locks the storage box. The storage unit 16 is thus able to keep the delivery, etc., safely until the user takes it out.

As shown in FIG. 2, the storage boxes making up the storage unit 16 include three types of storage boxes: the dedicated mailbox 161 that stores an article, such as a mail addressed to the user, and that is provided for each individual ownership space (dwelling unit), a dedicated box 162 that stores an article, such as a delivery to the user, and that is provided for each individual ownership space (dwelling unit), and a common use box 163 that stores an article, such as a delivery to the user, and that can be used in common by all users.

Out of the above storage boxes, the mailbox 161 and the dedicated box 162 store only the articles addressed to the same dwelling unit and do not store articles addressed to other dwelling units.

For example, when two users, i.e., users A and B reside in a dwelling unit with a room number “101” in a condominium, articles addressed to the users A and B are both stored in the mailbox 161 or dedicated box 162 allocated to the dwelling unit.

Meanwhile, the common use box 163 can store deliveries addressed to any one of users residing in the condominium.

When a delivery to a user is already stored in the common use box 163 of the storage apparatus 10 and the common use box 163 is closed and locked, only the user (or, in some cases, another user residing in the same dwelling unit) is allowed to unlock the common use box 163 of the storage apparatus 10 and users of other dwelling units and a delivery person from a shipping carrier are not allowed to unlock the common use box 163.

To store another article in the common use box 163 of the storage apparatus 10, an article already stored therein must be taken out to leave the common use box 163 empty. Storing another article therein is then allowed.

The above storage boxes 161, 162, and 163 are configured such that they can be unlocked by entering common authentication information set for each individual ownership space (dwelling unit), using the information input unit 15.

In other words, common authentication information is assigned to the users A and B residing in the same dwelling unit and is managed by the storage apparatus 10, etc. Using the common authentication information, the users A and B are able to unlock the mailbox 161 and dedicated box 162 allocated to the dwelling unit in which the users A and B reside as well as the common use box 163 storing articles addressed to the users A and B.

As shown in FIG. 2, the mailbox 161 and the dedicated box 162 for the same individual ownership space (dwelling unit) are located adjacent or close to each other.

“Located close to each other” means that the mailbox 161 and the dedicated box 162 are separated apart across one or two storage boxes.

In the example of FIG. 2, the common use box 163 is located distant from the mailbox 161 and the dedicated box 162. The common use box 163, however, may be located adjacent or close to the mailbox 161 and the dedicated box 162.

The mailbox 161 is a storage box that is allocated to each individual ownership space (dwelling unit) for exclusive use by a user residing in the individual ownership space (dwelling unit). The mailbox 161 has a lockable door whose front surface is partly cut out into an opening used as a throw-in port. Through this throw-in port, a mail, etc., is thrown in so that an article, such as a mail, can be stored in the mailbox 161 without opening the door.

The mailbox 161 stores therein, for example, small deliveries including mails, mail delivery service packages, newspaper, and handbills that are small enough to be thrown into the throw-in port.

Even if an article is already stored in the mailbox 161, another article can be additionally stored in the mailbox 161 through the throw-in port. In other words, a plurality of articles may be stored in the mailbox 161 in the same period.

To take an article out of the mailbox 161, its door needs to be unlocked by user authentication.

Similar to the mailbox 161, the dedicated box 162 is a storage box that is allocated to each individual ownership space (dwelling unit) for exclusive use by a user residing in the individual ownership space (dwelling unit), and has a lockable door.

The dedicated box 162 stores therein, for example, deliveries that are too large to be thrown into the throw-in port of the mailbox 161.

When unlocking the dedicated box 162, the user or a worker uses authentication information. The user is, however, allowed to unlock only the user's dedicated box 162 using the authentication information and is not allowed to unlock other users' dedicated boxes 162 using the authentication information.

The dedicated box 162 is configured such that it can be unlocked by the user and the worker using the authentication information, regardless of whether an article is stored in the dedicated box 162. Even when an article is already stored in the dedicated box 162, therefore, the worker is able to unlock the dedicated box 162 and store an additional article therein.

In this manner, in each dedicated box 162, a plurality of articles addressed to the user, to whom the box 162 is allocated, in several times of delivery operations can be stored so far as the box 162 has a storage space to accommodate an article. This prevents a case of shortage in storage boxes, thus offering a comparative advantage over a conventional home-delivery locker, etc., in which one delivery is stored in one storage box.

Similar to the dedicated box 162, the common use box 163 stores therein, for example, deliveries that are too large to be thrown into the throw-in port of the mailbox 161.

While the dedicated box 162 is a storage box allocated to each individual ownership space, the common use box 163 is a common storage box that, in principle, can be used by all users in the residential/use facility, and can store any article addressed to any one of the entire users.

An article is stored in the common use box 163 when, for example, a person who does not have authentication information for unlocking the dedicated box 162 intends to store an article or the dedicated box 162 is already occupied and a new article cannot be stored therein.

The common use box 163 is configured such that when an article is already stored therein, another article cannot be stored in the common use box 163 unless the stored article is taken out, which is different from the case of the dedicated box 162.

Similar to the dedicated box 162, the common use box 163 has a lockable door and therefore requires authentication for unlocking and opening the common use box 163 when an article is stored in the common use box 163. When no article is stored in the common use box 163, on the other hand, authentication for unlocking and opening is unnecessary and the common use box 163 can be unlocked and opened by an operation on the information input unit 15 (punching a key, etc.).

In the dedicated box 162 and the common use box 163, an article detecting unit 1615 that detects an article stored is provided. This article detecting unit 1615 may be configured to connect to the control unit 11.

In such a case, the control unit 11 can confirm (detect) that an article is stored in the dedicated box 162 and in the common use box 163, based on an incoming signal from the article detecting unit 1615.

The article detecting unit 1615 is composed of, for example, an optical sensor, such as an infrared sensor, a weight sensor, or the like.

Configurations of the dedicated box 162 and the common use box 163 will then be described in detail.

In the following description, for simplicity, the dedicated box 162 and the common use box 163 are referred to as storage box 162 and storage box 163.

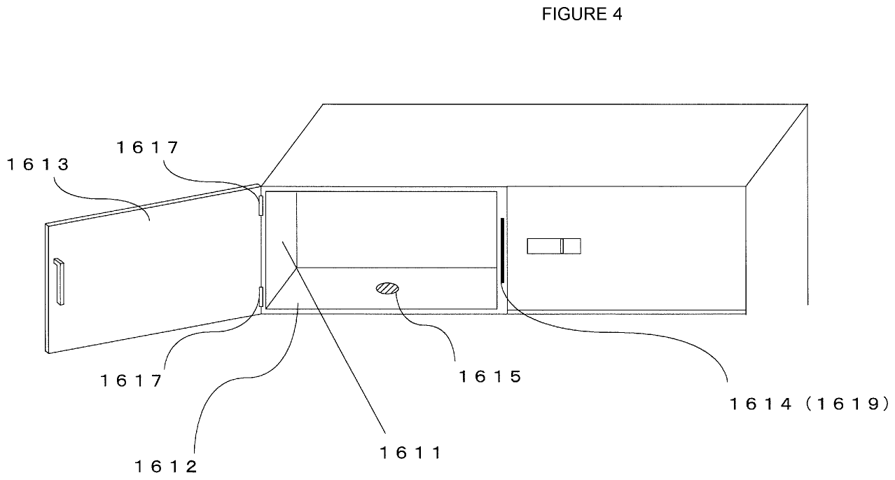

FIG. 4 is an external view of the front side of the storage box 162 or storage box 163 according to the first embodiment of the present invention.

As shown in FIG. 4, the storage box 162 (163) has a storage chamber 1611 serving as a storage space for a delivery, etc., addressed to the user, a storage/retrieval opening 1612 serving as an inlet/outlet for storing/retrieving a delivery, etc., a door 1613 serving as an openable/closable member that closes the storage/retrieval opening 1612 when locked, a locking/unlocking unit 1614 composed of an electric lock, etc., that locks the door 1613 closing the storage/retrieval opening 1612 and that when receiving an incoming unlocking signal from the control unit 11, unlocks the door 1613, the article detecting unit 1615 that detects an article stored in the storage chamber 1611, hinges 1617 connecting the storage chamber 1611 to the door 1613, and a hook 1618 attached to the back of the door 1613.

The storage chamber 1611 is a box of a rectangular parallelepiped having at least one open face.

The storage chamber 1611 and the door 1613 are made of, for example, iron, nonferrous metal, or alloy, and have strength that is high enough to prevent the storage chamber 1611 and the door 1613 from being easily broken by an external force when the door is closed.

The door 1613 is fitted turnably to the storage chamber 1611 via the hinges 1617.

On the back of the door 1613, the hook 1618 is attached.

An urging force is applied to the door 1613 of the storage box 162 (163), where the urging force acts on the direction of opening the door 1613. When the door 1613 is unlocked by the locking/unlocking unit 1614, therefore, the door 1613 opens automatically.

When the user has placed an article in the storage box 162 (163) and intends to lock the door 1613, for example, the user pushes the door 1613 against the urging force to close the door 1613. This action automatically locks the door 1613.

The locking/unlocking unit 1614 has an ordinary electronic lock or mechanical lock, and is not limited to a specific form of locking mechanism.

This embodiment will be further described on the assumption that, for example, the locking/unlocking unit has an electronic lock.

When the storage box 162 (163) is locked, the locking/unlocking unit 1614 fixes the door to a position at which the door keeps closing the storage/retrieval opening of the storage chamber, thus preventing the door from opening. In this case, an article stored in the storage box 162 (163) cannot be retrieved from outside and an article cannot be stored in the storage box 162 (163), either.

The locking/unlocking unit 1614 has a hook hole 1619, in which the hook 1618 is inserted when the door is closed, on the opening surface of the storage chamber 1611.

The locking/unlocking unit 1614 also has a door opening/closing detecting unit 1619c on the inner part of the hook hole 1619, the door opening/closing detecting unit 1619c working as a sensor that detects the opening/closing of the door 1613.

The door opening/closing detecting unit 1619c has, for example, a switch-like member. When the hook 1618 is inserted in the hook hole 1619, the front end of the inserted hook 1618 presses the switch-like member of the opening/closing detecting unit 1619c. This allows the door opening/closing detecting unit 1619c to detect the closing of the door 1613.

The locking/unlocking unit 1614 also has a latching portion that latches the inserted hook 1618 in the hook hole 1619 to restrict the move of the hook 1618.

The hook 1618 and the latching portion are made of, for example, metal but the material of the hook 1618 and latching portion is not limited to metal.

For example, a latching member of the latching portion that latches the hook 1618 is provided as a metal lever, etc., which is operated to come in contact with the hook 1618, thus latches the hook 1618 and preventing the door from opening.

The locking/unlocking unit 1614 is connected to the control unit 11 via a communication cable, etc, so as to be able to communicate with the control unit 11.

The control unit 11 receives an incoming unlocking request signal requesting unlocking of the storage box 162 (163). When accepting the unlocking request to permit the unlocking, the control unit 11 outputs an unlocking signal to the locking/unlocking unit 1614 of the storage box 162 (163).

Upon receiving the incoming unlocking signal, the locking/unlocking unit 1614 releases the hook 1618 from its latched state by operating the lever of the latching portion, thereby unlocks the storage box 162 (163).

When the storage box 162 (163) is locked, the locking/unlocking unit 1614 detects the locked state of the storage box 162 (163) and transmits a locking detection signal to the control unit 11. The locking/unlocking unit 1614 (door opening/closing detecting unit 1619c) detects also the opened state or closed state of the door 1613 and transmits a door opening detection signal or door closing detection signal indicating the detected opened state or closed state, to the control unit 11.

An operation for locking the storage box 162 (163) will first be described.

When the door 1613 is shut to close the storage/retrieval opening 1612, the hook 1618 attached to the back of the door 1613 is inserted in the hook hole 1619 of the locking/unlocking unit 1614 provided on the storage chamber 1611. When the front end of the hook 1618 presses the door opening/closing detecting unit 1619c provided on the inner part of the hook 1619, the door opening/closing detecting unit 1619c detects the closing of the door 1613.

Upon detecting the closing of the door, the door opening/closing detecting unit 1619c physically moves its member made of metal, etc., such as a lever and cam. This action may work as a trigger that causes the locking/unlocking unit 1614 to output a door closing detection signal to the control unit 11.

When the door opening/closing detecting unit 1619c detects the closing of the door 1613, the locking/unlocking unit 1614 operates its latching portion to latch and fix the hook 1618 inserted in the hook hole 1619 of the locking/unlocking unit 1614, thereby locks the door to prevent it from opening.

An operation for unlocking the storage box 162 (163) will then be described.

When receiving a request for unlocking the storage box 162 (163) and allowing unlocking of the storage box 162 (163), the control unit 11 creates an unlocking signal and outputs it to the locking/unlocking unit 1614.

Upon receiving the incoming unlocking signal from the control unit 11, the locking/unlocking unit 1614 moves the latching member of the latching portion to release the hook 1618 from its latched state, thereby unlocks the storage box 162 (163).

When the hook 1618 is released from the latching by the latching portion, the door 1613 becomes free to open.

In principle, each of the storage boxes 162 and 163 is locked in both cases of containing a delivery and not containing a delivery.

Once a delivery is placed in the storage box 162 (163), the storage box 162 (163) is locked and closed, thus keeping the delivery in a safe condition until the user to whom the delivery is addressed retrieves the delivery. When a delivery is stored in the storage box 162 (163), authentication of the user to whom the delivery is addressed is carried out, and when the authentication is successful, the storage box 162 (163) is unlocked.

The article detecting unit 1615 is a sensor that detects an article stored in the storage chamber 1611.

The article detecting unit 1615 is connected to the control unit 11 via a communication cable, etc., so as to be able to communicate with the control unit 11.

When detecting an article stored, the article detecting unit 1615 transmits an article detection signal to the control unit 11.

When receiving the article detection signal, locking detection signal, and door opening detection signal or door closing detection signal, the control unit 11 writes the use status of the storage box 162 (163) to the storage box DB 122, based on these detection signals.

The article detecting unit 1615 is, for example, an ordinary infrared sensor having an optical projector and an optical receiver. In this case, the optical projector emits infrared into the storage chamber 1611 in which the optical receiver receives the emitted infrared. If an article is present in the storage chamber 1611, the article blocks the emitted infrared to make it impossible for the optical receiver to receive the infrared. Hence, in this situation, the article detecting unit 1615 detects the article in the storage chamber 1611.

When the optical receiver is of a type that receives a reflected portion of infrared emitted from the optical projector, if an article is present in the storage chamber 1611, the infrared is reflected on the surface of the article. As a result, the optical receiver receives a reflected portion of infrared from the article, thus detecting the presence of the article.

In another case, for example, the article detecting unit 1615 has a weight scale.

When the article detecting unit 1615 is of a type having such a weight scale, the weight scale is placed on the bottom of the storage chamber 1611. When an article is put in the storage chamber 1611, the weight scale detects the weight of the article. The article detecting unit 1615 thus detects the presence of the article in the storage chamber 1611.

### (3) Configuration of Control Unit 11

The control unit 11 is a processing unit that performs overall control over the storage apparatus 10, and is composed of, for example, an electronic circuit, such as a CPU (Central Processing Unit), or an integrated circuit, such as an FPGA (Field-Programmable Gate Array).

The control unit 11 reads information out of the information storage unit 12 and writes information to the information storage unit 12.

The control unit 11 carries out control of operations of the storage box, such as locking/unlocking the storage box and opening/closing the door, the authentication process to be carried out when the storage apparatus 10 is used, management of the user's personal information and use status of the storage box, or the like.

### (4) Configuration of Information Storage Unit 12

The information storage unit 12 is an information storage device composed of, for example, a hard disc, a memory, a semiconductor element, or the like.

The information storage unit 12 has an area storing programs executed by the control unit 11, and a work area (RAM, tec.) that the control unit 11 uses temporarily when executing a process.

The control unit 11 reads programs out of the information storage unit 12 and loads the programs onto the work area to execute various processes.

The information storage unit 12 includes various databases, which will be described later.

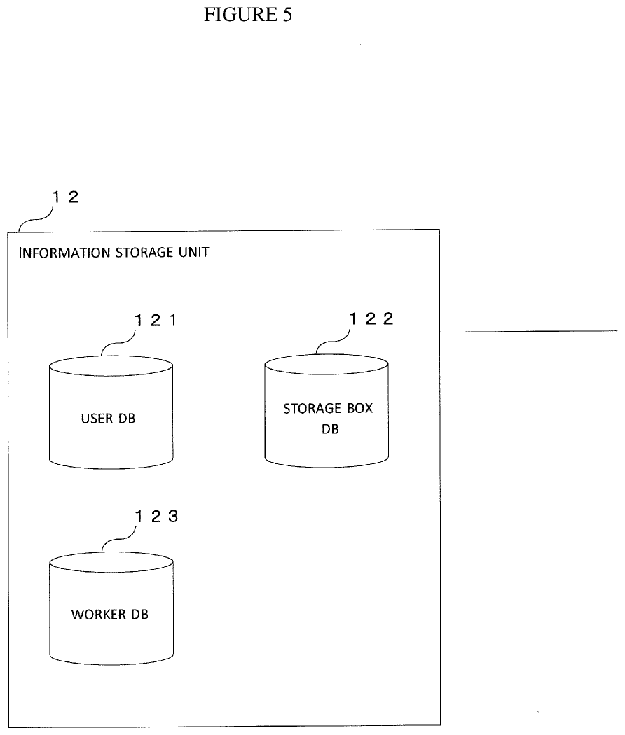

FIG. 5 is a diagram showing the databases included in the information storage unit 12 of the storage apparatus 10 according to the first embodiment of the present invention.

As shown in FIG. 5, the information storage unit 12 includes a user DB 121 that manages authentication information, etc., such as a password, that is needed when the user unlocks the storage unit 16, a storage box DB 122 that manages the status of storage of articles in the storage boxes 162 and 163, and a worker DB 123 that manages authentication information, etc., such as a password, that is needed when a worker unlocks the storage unit 16.

In addition to the databases 121 to 123, the information storage unit 12 includes also records of history information on storage of articles in the dedicated box 162 and the common use box 163 and history information on retrieval of articles from the dedicated box 162 and the common use box 163.

The contents of the history information include, for example, the box number of a storage box, a user ID or worker ID entered for storage or retrieval, and a time at which the storage box is unlocked for storage or retrieval, the box number, the ID, and the time being associated with each other. These contents are written also to the storage box DB 122 and are therefore reflected in its data contents.

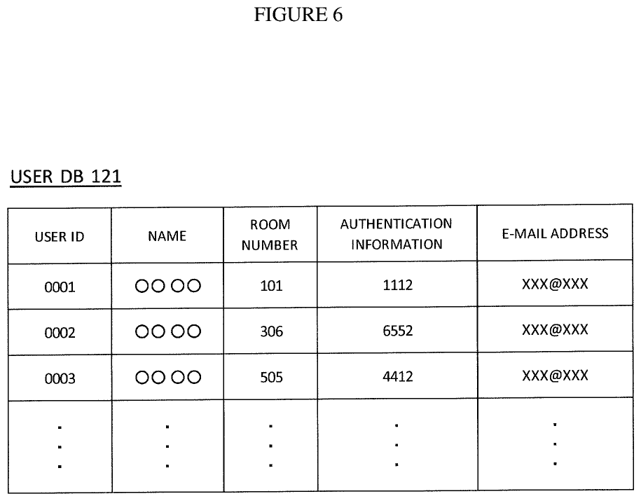

FIG. 6 is a diagram showing an example of a data configuration of the user DB 121 according to the first embodiment of the present invention.

In the example of FIG. 6, the user DB 121 associates user names, user's individual ownership space information (room numbers), authentication information for unlocking the storage box, and mail addresses with IDs for identifying users (user IDs) to manage the associated information.

In this embodiment, authentication information is set for each individual ownership space, and such authentication information is managed in the user DB 121 in the above manner. Specifically, according to this embodiment, for example, the same authentication information is assigned to users residing in or using the same individual ownership space, and is managed in the user DB 121.

In the example of FIG. 6, the user DB 121 manages mail addresses as user contact information (user terminal 30, etc.). However, user contact information is not limited to mail addresses, and any information providing contact links to users may be adopted.

The user is allowed to unlock only the mailbox 161 and dedicated box 162 allocated to the user (user's individual ownership space), using authentication information assigned to the user, and is not allowed to unlock other users' mailboxes 161 and dedicated boxes 162 having nothing to do with the user's individual ownership space, using the authentication information on the user.

The user is allowed to unlock the common use box 163, using the authentication information on the user, only when an article addressed to the user or to a different user residing in or using the user's individual ownership space is stored in the common use box 163. The user is, therefore, not allowed to unlock other common use boxes 163 storing articles addressed to other users different from the user and different user residing in or using the user's individual ownership space.

The authentication information on the user (user's individual ownership space) is authentication information used in common to unlock the mailbox 161 and dedicated box 162 allocated to the user's individual ownership space and the common use box 163 storing an article addressed to the user.

In other words, a mailbox 161 allocated to a certain individual ownership space, a dedicated box 162 allocated to the individual ownership space, and a common use box 163 storing an article addressed to the user residing in or using the individual ownership space can all be unlock, using common authentication information.

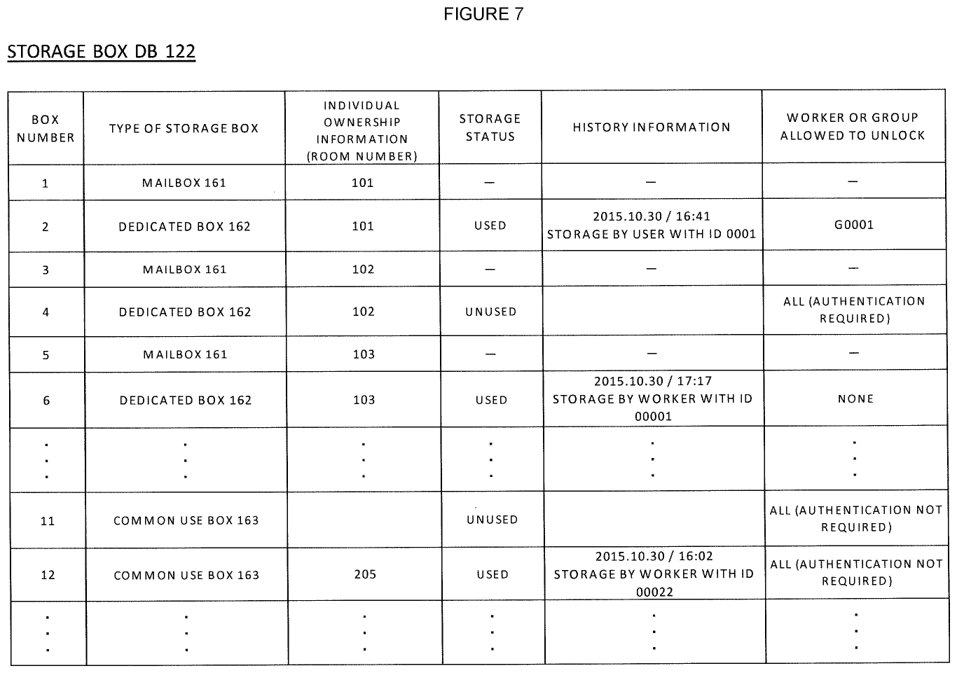

FIG. 7 is a diagram showing an example of a data configuration of the storage box DB 122 according to the first embodiment of the present invention.

In the example of FIG. 7, the storage box DB 122 associates box numbers indicative of individual storage boxes with information of types of storage boxes (one of the mailbox 161, dedicated box 162, and common use box 163), individual ownership space information (room numbers) for identifying the individual ownership space of a user for the case of a storage box used exclusively by the user (mailbox 161, dedicated box 162), individual ownership space information (room numbers) on a user to whom an article is addressed for a case of using the common use box 163, article storage status (“Used” or “Unused” or the number of articles in the case of “Used”), history information indicating history of article storage and retrieval, and IDs for workers or groups (which will be described later) allowed to to unlock for a case of using the dedicated box 162 or common use box 163, to manage each of these data.

A storage box indicated as “Used” in the above data indicates a state in which an article is already stored in the storage box and an additional article cannot be placed in the storage box. “Unused”, in contrast, indicates a state in which no article is stored in the storage box and an article can be newly placed in the storage box.

For example, in the example of FIG. 7, a storage box indicated by a box number “2” is a dedicated box 162 allocated to a room number “101”, which is individual ownership space information. This storage box is currently “used (articles are stored in the storage box)”, and the number of articles stored is “3”.

According to the storage box DB 122, for example, in the example of FIG. 7, the storage box indicated by the box number “2” is the dedicated box 162 allocated to the room number “101”, which is individual ownership space information. An article is stored in this storage box at “16:14 on Oct. 30, 2015” by a user identified with a “user ID: 0001”, and the storage box can be unlocked by a worker belonging to a group identified with a group ID “G0001”.

The group identified with the ID is, for example, a group to which the worker belongs, such as a store, a corporation, a section in a company, an organization, or an institution. More specifically, the group may be a shipping carrier that delivers mails, deliveries, etc., a dry cleaning shop, a supermarket that provides a food delivery service, or the like.

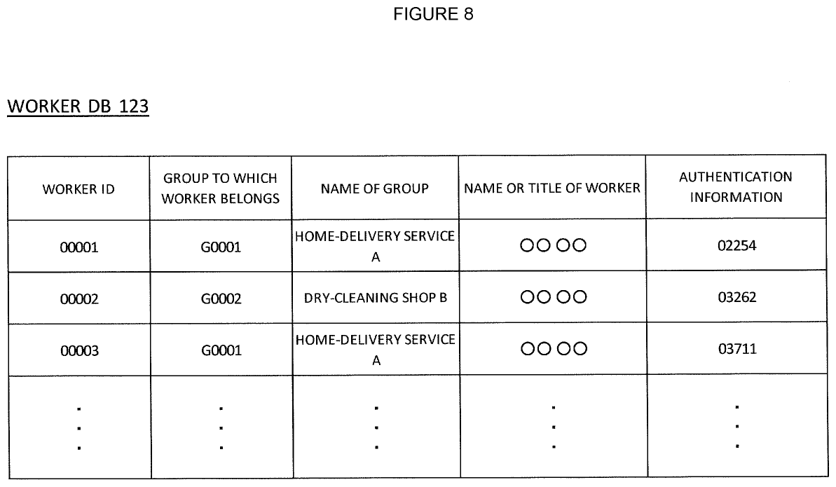

FIG. 8 is a diagram showing an example of a data configuration of the worker DB 123 according to the first embodiment of the present invention.

The worker DB 123 shown in FIG. 8 associates worker IDs for identifying individual workers with groups to which the workers belong (corporations, stores, etc.), the names of the groups to which the workers belong, the names or titles of the workers, and authentication information for unlocking the dedicated box 162 or common use box 163, to manage these data.

When a worker enters authentication information on the worker, using the information input unit 15, the control unit 11 of the storage apparatus 10 determines whether the authentication information is registered with the worker DB 123 and, referring to the storage box DB 122, determines whether a storage box 162 or storage box 163 the worker authenticated by the authentication information is allowed to unlock is present, and then carries out authentication.

When the authentication is successful, the worker is allowed to unlock the storage box 162 or storage box 163 and is therefore able to store and retrieve an article in and from the storage box 162 or storage box 163.

### (5) Configuration of Communication Unit 13

The communication unit 13 is an interface that controls communication with the management server 20, the communication being carried out through the network 100. The communication unit 13 has a LAN adaptor, etc.

The communication unit 13 has a radio transceiver, and may be connected to a LAN, Internet, etc., via wireless communication means or wired communication means, such as a cable.

### (6) Configurations of Display Unit 14 and Information Input Unit 15

The display unit 14 is a display device including a panel, such as a liquid crystal panel and an organic EL (Electro Luminescence) panel, or a lamp composed of a light-emitting element, such as an LED.

The control unit 11 reads an image out of the information storage unit 12 and executes an image output process to create image information.

The control unit 11 outputs the created image information to the display unit 14.

The display unit 14 displays the above incoming image information on the display, etc.

Further, the control unit 11 may output a control signal to the display unit 14 to turn on the lamp the display unit 14 has.

The information storage unit 15 has an information input device including, for example, various keys, and this information input device works together with the display unit 14 to provide a pointing device. The information storage unit 15 receives various operations carried out by the user, etc., and outputs a signal indicative of the contents of the operations to the control unit 11, etc.

When receiving the incoming signal indicative of the contents of the operations, the control unit 11, according to the contents indicated by the signal, outputs a control signal for causing the display unit 14 to make screen display corresponding to the contents of the operations, to the display unit 14.

Upon receiving the control signal, the display unit 14 makes screen display according to the control signal.

The display unit 14 and the information input unit 15 may be configured integrally to form a touch panel.

The information input unit 15 has an information reader that reads information from an information recording medium through short-range radio communication, such as infrared communication.

The user holds an information recording medium recoding thereon authentication information for unlocking the storage box, up over the information input unit 15 (information reader), thus bringing the information recording medium closer to put it in a given distance range to the information input unit 15. The information input unit 15 then reads the authentication information from the information recording medium.

An authentication information reading technique adopted by the information input unit 15 is not limited to a specific technique. For example, a short-range radio communication system, such as Felica, MIFARE, NFC (Near Field Communication), and Bluetooth, may be adopted. When the surface of the information recording medium is printed or provided with coded information, the information input unit 15 optically reads such coded information.

The information recording medium is, for example, a non-contact type IC card carrying written authentication information for identifying a user or a portable terminal functioning in the same manner as the IC card.

The information input unit 15 has also a function of reading a bar code, a two-dimensional bar code, or coded information made up of letters and figures.

### [3] Configuration of Management Server 20

### (1) Over all Configuration of Management Server 20

The management server 20 is an information processing device that manages user information and the status of storage of articles addressed to the user in the storage apparatus 10. The management server 20 is installed inside or outside the residential/use facility.

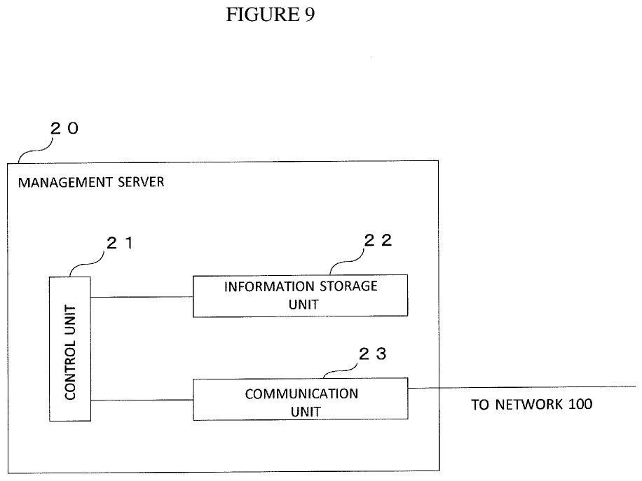

FIG. 9 is a diagram showing a configuration of the management server 20 according to the first embodiment of the present invention.

As shown in FIG. 9, the management server 20 includes a control unit 21 that performs overall control over the management server 20, an information storage unit 22 storing therein user information and information on article status, etc., and a communication unit 23 that transmits and receives various pieces of information between the storage apparatus 10 and the user terminal 30.

The units 21 to 23 are each connected to an internal bus, through which various pieces of information is input and output to execute various processes under control by the control unit 21.

The control unit 21 is a processing unit that performs overall control over the management server 20, and is composed of, for example, an electronic circuit, such as a CPU (Central Processing Unit), or an integrated circuit, such as an FPGA (Field-Programmable Gate Array).

The control unit 21 reads information out of the information storage unit 22 and writes information to the information storage unit 22.

The information storage unit 22 is an information storage device composed of, for example, a hard disc, a memory, a semiconductor element, or the like.

The information storage unit 22 has an area storing programs executed by the control unit 21, and a work area (RAM, tec.) that the control unit 21 uses temporarily when executing a process.

The control unit 21 reads programs out of the information storage unit 22 and loads the programs onto the work area to execute various processes.

The communication unit 23 is an interface that controls communication with the storage apparatus 10 or user terminal 30, the communication being carried out through the network 100. The communication unit 23 has a LAN adaptor, etc.

The communication unit 23 has a radio transceiver, and may be connected to a LAN, Internet, etc., via wireless communication means or wired communication means, such as a cable.

### (2) Configuration of Information Storage Unit 22

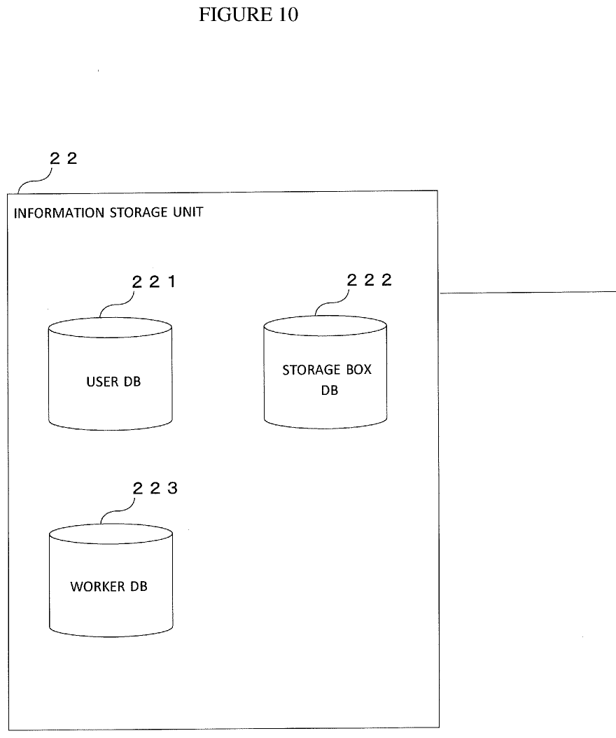

FIG. 10 is a diagram showing databases 221 and 222 included in the information storage unit 22 of the management server 20 according to the first embodiment of the present invention.

As shown in FIG. 10, the information storage unit 22 includes a user DB 221 that manages users' personal information, a storage box DB 222 that manages information on the status of storage of articles addressed to users, and a worker DB 223 that manages authentication information, such as a password, that a worker needs when unlocking the storage unit 16.

Each of pieces of information managed by the database 121 and by the database 221 is synchronized between the database 121 and the database 221 on a regular basis or every time one version of the same information out of two versions of the same information managed by the databases 121 and the database 221 is updated, through communication between the storage apparatus 10 and the information providing server 20. This synchronization process keeps information in the databases 121 and 221 updated in synchronization.

In the same manner, information managed by the database 122 and by the database 222 as well as information managed by the database 123 and by the database 223 is also synchronized.

### [4] Configuration of User Terminal 30

### (1) Overall Configuration of User Terminal 30

The user terminal 30 is an information processing device operated by a user to whom an article is delivered.

The user terminal 30 is, for example, a portable information processing device, such as a smart phone, a tablet terminal, a wearable terminal, a cellular phone, a PDA, a PHS, and a PC.

The user terminal 30 receives article storage information on an article addressed to the user, from the management server 20 and displays the article storage information or outputs a voice message notifying of the information.

The article storage information informs the user that an article addressed to the user is stored and kept in the storage apparatus 10, and prompts the user to retrieve the article in the user's early opportunity. For example, the article storage information includes a time at which the article is stored, and the box number of a storage box in which the article is stored.

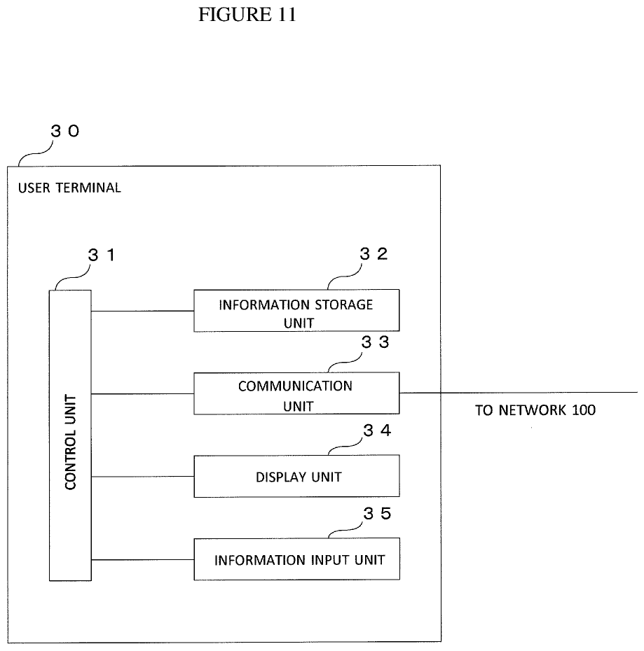

FIG. 11 is a diagram showing a configuration of the user terminal 30 according to the first embodiment of the present invention.

As shown in FIG. 11, the user terminal 30 includes a control unit 31 composed of a CPU or the like, the control unit 31 performing overall control over the user terminal 30, an information storage unit 32 storing various pieces of information, such as a user ID for a user who operates the user terminal 30, a communication unit 33 that exchanges information with the management server 20 through the network 100, such as the Internet, a display unit 34 that displays various pieces of information, and an information input unit 35 that includes various keys and buttons to allow input of various pieces of information.

The display unit 34 and the information input unit 35 may be configured integrally to make up a touch panel.

The units 31 to 35 are each connected to an internal bus, through which various pieces of information are input and output to execute various processes under control by the control unit 31.

The control unit 31 is a processing unit that performs overall control over the user terminal 30, and is composed of, for example, an electronic circuit, such as a CPU (Central Processing Unit), or an integrated circuit, such as an FPGA (Field-Programmable Gate Array).

The control unit 31 reads information out of the information storage unit 32 and writes information to the information storage unit 32.

The information storage unit 32 is an information storage device composed of, for example, a hard disc, a memory, a semiconductor element, or the like.

The information storage unit 32 has an area storing programs executed by the control unit 31, and a work area (RAM, tec.) that the control unit 31 uses temporarily when executing a process.

The control unit 31 reads programs out of the information storage unit 32 and loads the programs onto the work area to execute various processes.

The communication unit 33 is an interface that controls communication with the management server 20 or an account-settling server 40, the communication being carried out through the network 100. The communication unit 33 has a LAN adaptor, etc.

The communication unit 33 has a radio transceiver, and may be connected to a LAN, Internet, etc., via wireless communication means or wired communication means, such as a cable.

The display unit 34 is a display device composed of a panel, lamp, etc.

The control unit 31 reads an image out of the information storage unit 32 and executes an image output process to create image information. The control unit 31 also executes an image output process on image information that the communication unit 33 receives from the management server 40, to create image information.

The control unit 31 outputs the created image information to the display unit 34.

The display unit 34 displays the above incoming image information on the display, etc.

Further, the control unit 31 may output a control signal to the display unit 34 to turn on an LED lamp, etc., the display unit 34 has.

The information storage unit 35 has an information input device including, for example, various keys, and this information input device works together with the display unit 34 to provide a pointing device. The information storage unit 35 receives various operations carried out by the user, etc., and outputs a signal indicative of the contents of the operations to the control unit 31, etc.

When receiving the incoming signal indicative of the contents of the operations, the control unit 31, according to the contents indicated by the signal, outputs a control signal for causing the display unit 34 to make screen display corresponding to the contents of the operations, to the display unit 34.

Upon receiving the control signal, the display unit 34 makes screen display according to the control signal.

The user terminal 30 is able to receive screen information, such as a Web page, from the management server 20 functioning as a Web server and to display the screen information.

The user terminal 30 has a function of causing the control unit 31 to create and transmit an HTTP (Hypertext Transfer Protocol) request in response to a request from the user, and a function of interpreting an HTTP response (example of responses) to show the user the contents of the HTTP response.

For example, the information storage unit 32 includes a Web browser.

The control unit 31 interprets an HTTP response to create image data and sound data and displays an image on the display unit 34 or outputs a sound from a speaker the user terminal 30 has. In this manner, the control unit 31 shows the user the contents of the HTTP response.

### [5] Configurations of Authentication Media 41 and 42

The authentication media 41 and 42 are media recording thereon authentication information for unlocking the storage boxes of the storage apparatus 10. The authentication medium 41 is an authentication medium for users and the authentication medium 42 is an authentication medium for workers.

By entering authentication information recorded on the authentication media 41 and 42 in the storage apparatus 10, intended storage boxes 161 and 162 are unlocked.

Each of the authentication media 41 and 42 may be, for example, a medium with a memory in which authentication information is recorded magnetically, magneto-optically, or electrically, such as an IC card, or a medium having letter information or coded information printed or formed on its surface.

The authentication medium 41 may be configured integrally with the user terminal 30. In such a case, authentication information is stored in the information storage unit 32, and is transmitted and input to the information input unit 15 of the storage apparatus 10, using the short-range radio communication function, etc., of the communication unit 33.

When the worker has a terminal similar to the user terminal 30, the worker's terminal may be configured integrally with the authentication medium 42, as in the case of configuring the user's terminal integrally with the authentication medium 41, and authentication information can be input to the storage apparatus 10 in the same manner as in the case of the user's terminal 30.

Instead of using the authentication media 41 and 42, the user or worker may enter a password, using various keys of the information input unit 15, or cause the information input unit 15 to read biological information, such as information on fingerprints and iris, on the user or worker to input authentication information.

An unused common use box 163, in which no article is stored, can be unlocked by both worker and user without an authentication procedure. Such a common use box 163 can be unlocked by, for example, pressing a button provided on the information input unit 15 of the storage apparatus 10.

On the authentication medium 41 the user has, authentication information on the user set for the user or the user's dwelling unit is recorded.

Using the authentication medium 41, the user enters the authentication information in the storage apparatus 10. This allows the user to unlock the dedicated box 162 allocated to the user (user's dwelling unit) as well as the common use box 163 storing an article addressed to the user (user's dwelling unit).

On the authentication medium 42 the worker has, authentication information on the worker set for the worker or an organization, such as a company, to which the worker belongs or a section of the organization is recorded.

The worker is allowed to unlock the dedicated box 162 using the authentication medium 42, but is not allowed to unlock the mailbox 161 using the authentication medium 42.

As for the common use box 163, when an article addressed to the user is stored in the common use box 163, the worker is not allowed to unlock the common use box 163 even if the worker enters the authentication information using the authentication medium 42.

When the article stored in the common use box 163 is the article stored by the user, however, only the worker allowed to retrieve the article is allowed to unlock the common use box 163 by entering the authentication information using the authentication medium 42.

As mentioned above, when no article is stored in the common use box 163, the worker is allowed to unlock the common use box 163 without using the authentication medium 42, that is, without carrying out the authentication procedure.

### (Operations According to First Embodiment)

(1) Operations Carried Out when Worker Stores Article

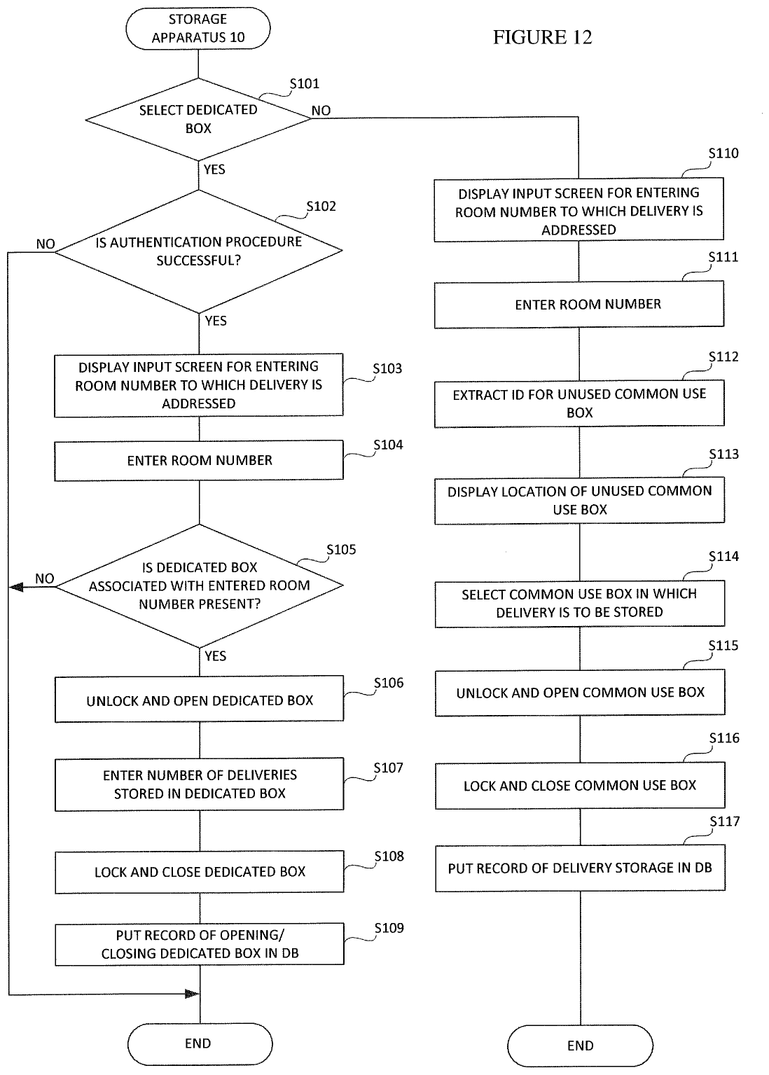

FIG. 12 is a flowchart of a flow of operations that are carried out by the storage apparatus 10 when a worker from a shipping carrier, etc., stores an article in the storage apparatus 10, according to the first embodiment of the present invention.

Operations carried out by the storage apparatus 10 when a worker stores an article, which is addressed to a user, in a storage box will hereinafter be described, referring to FIG. 12.

It is assumed in this example that the article the worker intends to store is a delivery, etc., and cannot be put in the mailbox 161 and is therefore placed in either the dedicated box 162 or the common use box 163.

The worker carrying a delivery to the user visits a location where the storage apparatus 10 is installed, such as the entrance of a condominium.

When the worker selects “article storage” on the information input unit 15 of the storage apparatus 10, as the purpose of use of the storage apparatus 10, icons for selecting “dedicated box” and “common use box” are displayed on the display unit 14.

The worker selects a storage box in which a delivery is to be stored, from the “dedicated box” and “common use box” icons displayed on the display unit 14 (step S101).

When having selected the dedicated box 162 (step S101: Yes), the worker holds the authentication medium 40 up over the information input unit 15 for the authentication procedure. In response to this, the information input unit 15 of the storage apparatus 10 reads a worker ID and authentication information written on the authentication medium 40. The control unit 11 then refers to the storage box DB 122 and the worker DB 123 to determine whether the read worker ID and authentication information are associated with each other and stored in both DBs and also determine whether the worker identified with the worker ID is allowed to unlock the dedicated box 162 (step S102).

When the worker ID and authentication information are not associated with each other in both DBs or when the worker ID and authentication information are associated but the worker is not allowed to unlock the dedicated box 162 (step S102: No), the control unit 11 determines that the authentication procedure has failed, and ends the operations.

When the worker ID and authentication information are associated with each other in both DBs and the worker is allowed to unlock the dedicated box 162 (step S102: Yes), the control unit 11 determines that the authentication procedure is successful, and causes the display unit 14 to display an input screen for inputting a room number (individual ownership space) to which the delivery is addressed (step S103).

Subsequently, the worker checks a slip, etc., attached to the delivery and enters the room number, to which the delivery is addressed, in an entry space on the room number input screen displayed by the display unit 14, using the information input unit 15 (step S104).

In response to this, the control unit 11 refers to the storage box DB 122 to determine whether the dedicated box 162 associated with the entered room number is present (step S105).

When finding on dedicated box 162 associated with the entered room number, that is, when determining that the user identified with the room number does not use a storage service of storing an article in the dedicated box 162 (step S105: No), the control unit 11 ends the processes.

Afterward, the worker selects “common use box” at step S101 (step S101). Operations to follow after selection of “common use box” will be described in detail later.

When determining that the dedicated box 162 associated with the entered room number is present (step S105: Yes), the control unit 11 allows the worker to unlock and open the dedicated box 162 (step S106).

The worker checks the storage status of the opened dedicated box 162, and places deliveries, which the worker has brought in as this round of delivery, in an empty space in the dedicated box 162 such that the amount of deliveries corresponds to the size of the space. The worker then enters the number of the stored deliveries, using the information input unit 15 (step S107).

Subsequently, the worker closes and locks the dedicated box 162 (step S108).

At this time, the control unit 11 puts a record of the worker's unlocking and opening the dedicated box 162 for the purpose of storing the delivery (or deliveries), in the storage box DB 122 (step S109). Specifically, the control unit 11 records the worker ID entered at step S102, information indicating the delivery (deliveries) having been stored in the dedicated box 162, the number of the stored deliveries, and time information indicating the date, etc., in the corresponding entry spaces in the field of the dedicated box 162 in the storage box DB 122.

This is the end of the whole operation.

When the dedicated box 162 has no extra space to accommodate the delivery, the worker does not store the delivery, and enters “0” as the number of stored deliveries or does not enter any number at all (step S107), and then closes and locks the dedicated box 162 (step S108).

At this time, as in the above case of storing the delivery, the control unit 11 puts a record of the worker's unlocking and opening the dedicated box 162 for the purpose of storing the delivery (or deliveries), in the storage box DB 122 (step S109).

Specifically, the control unit 11 records the worker ID entered at step S102, information indicating no delivery (deliveries) having been stored in the dedicated box 162, and time information indicating the date, etc., in the corresponding entry spaces in the field of the dedicated box 162 in the storage box DB 122.

The operations carried when storage in the dedicated box 162 is selected at step S101 have been described above. Operations carried out when storage in the common use box 163 is selected will hereinafter be described.

When the worker selects the common use box 163, in which a delivery is to be stored, from displayed icons of “dedicated box” and “common use box” displayed on the display unit 14, using the information input unit 15 of the storage apparatus 10 (step S101: No), the display unit 14 displays the room number input screen (step S110).

Subsequently, on the room number input screen, the worker enters the user's room number to which the delivery is addressed, using the information input unit 15 (step S111).

In place of the room number, the worker may enter other type of information if the information identifies the user to whom the delivery is addressed.

Subsequently, the control unit 11 refers to the storage box DB 122 to identify an unused common use box (or unused common use boxes) 163 and extract the storage box ID for the common use box 163 (step S112).

Based on the extracted storage box ID, the control unit 11 causes the display unit 14 to display the location, etc., of the unused common use box 163 (step S113).

Subsequently, the worker selects a desired common use box 163 from one or more unused common use boxes 163 displayed on the display unit 14, using the information input unit 15 (step S114).

The control unit 11 allows the worker to unlock and open the selected common use box 163 (step S115).

The worker stores the delivery in the opened common use box 163, and closes and locks the common use box 163 (step S116).

The control unit 11 then puts a record of the worker's storing the delivery in the common use box 163, in the storage box DB 122 (step S117). Specifically, the control unit 11 records the room number or user ID corresponding thereto entered at step S111 and time information indicating the date, etc., in the corresponding entry spaces (individual ownership space information entry space, history information entry space) in the field of the common use box 163 in the storage box DB 122.

Afterward, the user visits the location where the storage apparatus 10 is installed, and causes the storage apparatus 10 to read information from the user's authentication medium 41, using the information input unit 15. Based on the information read from the authentication medium 41, the storage apparatus 10 carries out the authentication procedure. If the authentication procedure is successful, the storage apparatus 10 unlocks and opens the common use box 163. This is the end of the whole processes.

When the worker closes and locks the storage box without storing a delivery therein, as in the above described case, the display unit 14 prompts the worker to store the delivery in an unused common use box 163 by displaying its location, etc. The control unit 11 may recognize the fact that the storage box is closed without storing the delivery therein, by the following processes.

For example, after closing and locking the storage box without storing the delivery therein, the worker enters information indicating that fact, using the information input unit 15 (pressing a given button, etc.). The control unit 11 thus recognizes the fact.

In another process, the weight scale of the article detecting unit 1615 provided in the dedicated box 162 or common use box 163 may measure the weight of the delivery in the box before opening of the box and the same after closing of the box and output the resulting measurements to the control unit 11. In this case, the control unit 11 compares the weight information input by the weight scale of the article detecting unit 1615 before opening of the box with the weight information input by the same after closing of the box, and when the weight measured after closing of the box does not indicate an increase from the weight measured before opening of the box, determines that the worker has closed and locked the dedicated box 162 or the common use box 163 without storing the delivery therein.

Still another process may also possible, according to which the article detecting unit 1615 senses a change in the storage status in the dedicated box 162 or the common use box 163, using the function as the infrared sensor.

As described above, when the worker intends to store the article addressed to the user, the storage apparatus 10 provides the worker with information of the dedicated box 162 and the common use box 163 indicated as “storage allowed”. Because of this process, even if all the common use boxes 163 are occupied with articles and no article can be newly stored therein, an article can be stored smoothly in an available storage box.

Furthermore, even when the worker does not have authentication information, the worker is able to store an article in an unused common use box 163 indicated as “storage allowed”. It is therefore possible to achieve smooth delivery work.

(2) Operations Carried Out when User Retrieve Article

After the worker stores an article addressed to the user in a storage box of the storage apparatus 10, as in the above case, the user having noticed that fact visits the location where the storage apparatus 10 is installed and retrieves the article addressed to the user from the storage box.

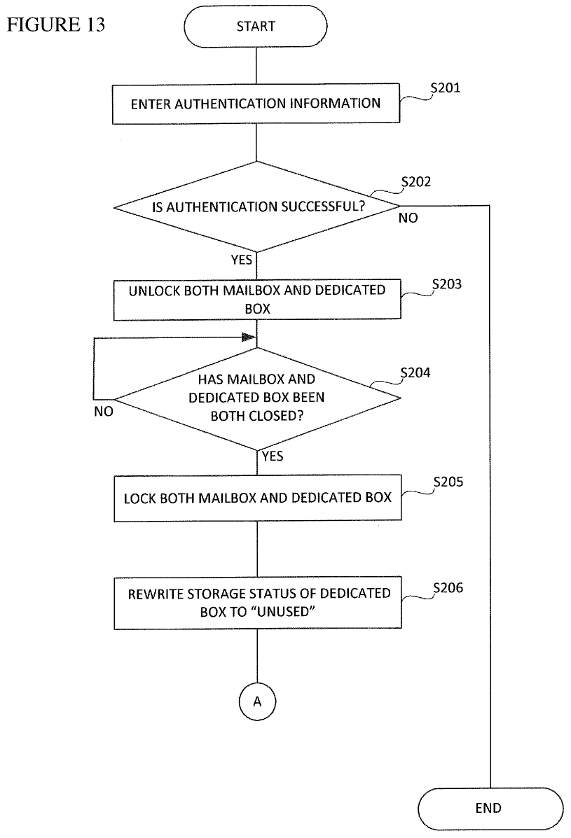

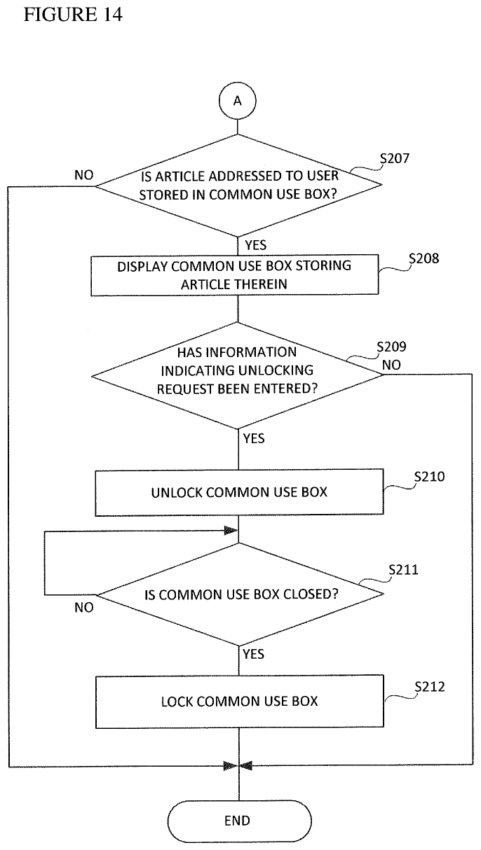

FIGS. 13 and 14 are flowcharts of flows of operations that are carried out by the storage apparatus 10 when a user retrieves an article from the storage apparatus 10, according to the first embodiment of the present invention.

Description will hereinafter be made, referring to FIGS. 13 and 14.

A user visits the entrance of a condominium in which the storage apparatus 10 storing an article addressed to the user is installed.

Operating the information input unit 15, the user enters authentication information on the user (password, etc.), together with information indicating an article retrieval request (step S201).

Methods of entering the authentication information include entering the authentication formation, such as a password, using numerical keys, etc., included in the information input unit 15, and causing the information input unit 15 to read the authentication information written on the authentication medium 40, using the short-range radio communication function, such as infrared communication, or the card reader function.

The control unit 11 refers to the user DB 121, identifies the user corresponding to the above read authentication information, and carries out the authentication procedure (step S202).

When determining that the above entered authentication information is not managed in the user DB 121 (step S202: No), the control unit 11 determines that the authentication procedure has failed, and ends the operations without unlocking a storage box.

When determining that the entered authentication information is managed in the user DB 121 (step S202: Yes), the control unit 11 determines that the authentication procedure is successful, and unlocks both the mailbox 161 allocated to the user and the dedicated box 162 located adjacent or close to the mailbox 161 (step S203).

The user opens both the mailbox 161 and the dedicated box 162 that have been unlocked, and when finding that articles addressed to the user are in both the storage boxes 161 and 162, takes the articles out and closes both the storage boxes.

When confirming that the mailbox 161 and the dedicated box 162 have been closed (step S204: Yes), the control unit 11 locks the storage boxes 161 and 162 (step S205), and writes a record of having retrieved an article from the dedicated box 162 to the storage box DB 122 to reflect the record therein (step S206).

Specifically, the control unit 11 changes an entry of the storage status of the dedicated box 162 in the storage box DB 122, from “used” to “unused”.

Subsequently, the control unit 11 refers to the storage box DB 122 to determine whether a common use box 163 storing therein an article addressed to the user is present (step S207).

In other words, the control unit 11 determines whether a common use box 163 associated with the user's room number (individual dwelling space information) and indicated as “used” in the storage box DB 122 is present.

When determining that a common use box 163 storing therein an article addressed to the user is not present (step S207: No), the control unit 11 concludes that every article addressed to the user has been retrieved from the storage apparatus 10 and therefore ends the operations.

When determining that a common use box 163 storing therein an article addressed to the user is present (step S207: Yes), the control unit 11 causes the display unit 14 to display the location of the common use box 163 (step S208).

In such a case where an article addressed to the user is stored in the common use box 163, the display unit 14 displays the location of the common use box 163 to prompt the user to retrieve that article after the user has retrieved an article from the dedicated box 162. The user, therefore, easily knows the status of storage of an article in the common use box 163 without bothering to check whether an article addressed to the user is stored in the common use box 163, and when an article is in the common use box 163, takes it out.

When taking the article out of the common use box 163, the user operates the information input unit 15 (presses a button, etc.) to enter information indicating a request for unlocking the common use box 163 (step S209: Yes).

When determining that the information indicating a request for unlocking the common use box 163 has been entered (step S209: Yes), the control unit 11 allows the user to unlock the common use box 163 (step S210).

The user then opens the unlocked common use box 163, takes the article address to the user out, and closes the common use box 163.

When confirming that the common use box 163 has been closed (step S211: Yes), the control unit 11 locks the common use box 163 (step S212) and ends the operations.

When the user has no intention to take the article address to the user out of the common use box 163, the user operates the information input unit 15 (presses a button, etc.) to enter information indicating the user having no intention to take the article out (step S209: No).

At this step, when a given time has elapsed from the point of time at which the display unit 14 displays the location of the common use box 163 as the information indicating a request for unlocking the common use box 163 is not entered, the control unit 11 may determine that information indicating the user having no intention to take the article out of the common use box 163 has been entered.

When determining that the information indicating the user having no intention to take the article out of the common use box 163 has been entered (step S209: No), the control unit 11 ends the operations without unlocking the common use box 163.

As described above, when an article addressed to the user is stored in the mailbox 161, the dedicated box 162, or the common use box 163, the user unlocks each of these storage boxes using common authentication information. This allows the user to easily retrieve the article addressed to the user by a simple operation.

(3) Operation of Providing User with Information on Article Storage Status

As described above, the storage apparatus 10 causes the storage box DB 122 to manage the storage status of each of the storage boxes.

Meanwhile, the management server 20 causes the storage box DB 222 to manage the same information as managed by the storage box DB 122.

When the user transmits an information acquisition request for acquiring information on the status of storage of an article in each storage box to the management server 20 through the network 100, using the user terminal 30, the control unit 21 of the management server 20, in response to the information acquisition request, extracts the information on the status of storage of an article from the storage box DB 222 and causes the communication unit 23 to transmit the extracted information to the user terminal 30.

Even in a case where the management server 20 does not receive an information acquisition request from the user terminal 30, when an article addressed to the user is stored in a storage box of the storage apparatus 10 and information indicating the article having been stored in the storage box is written to the storage box DB 122, the management server 20 may transmits the information to the user terminal 30 of the user to which the storage box is allocated.

As described above, the user is able to easily acquire information on whether a storage box of the storage apparatus 10 is empty or on whether an article addressed to the user is stored in the storage apparatus 10.

Using the user terminal 30, the user may make a request for acquiring such information to the storage apparatus 10 to acquire the information from the storage apparatus 10.

### (Summary of First Embodiment)

As described above, according to the first embodiment of the present invention, the storage apparatus 10 includes the mailbox 161 having the throw-in port, the mailbox 161 storing articles, such as mails, thrown into the mailbox 161 through the throw-in port, the dedicated box 162 allocated to each individual ownership space (dwelling unit), the dedicated box 162 storing articles, such as deliveries, and the common use box 163 that stores articles, such as deliveries, as the dedicated box 162 does, and that can be used in common by individual users residing in individual ownership spaces (dwelling units). The storage apparatus 10, therefore, can store therein various types of articles addressed to the user.

As described above, the storage apparatus 10 according to the first embodiment of the present invention includes the dedicated box 162 allocated to each individual ownership space (dwelling unit) in combination with the mailbox 161 allocated to each individual ownership space (dwelling unit). The mailbox 161 allocated to each individual ownership space and the dedicated box 162 allocated to each individual ownership space are thus located adjacent or close to each other. When articles addressed to the same user (individual ownership space) are stored in these storage boxes 161 and 162, therefore, the user is able to retrieve the articles all together, which offers a security advantage, thus allowing the user to retrieve the articles in a safe condition.

Specifically, the mailbox 161 and the dedicated box 162 being located close to each other prevents such a case where as the user takes an article out of one of the mailbox 161 and the dedicated box 162, a third party takes an article out of the other of these storage boxes.

According to the first embodiment of the present invention, even when the dedicated box 162 is in “used” status, if the worker finds a common use box 163 in “unused” status, the worker is allowed to store an article in that common use box 163. This makes the worker's work more efficient and allows the user to efficiently receive an article addressed to the user.

According to the first embodiment of the present invention, the storage apparatus 10 unlocks the mailbox 161, the dedicated box 162, and the common use box 163, based on common user authentication information. When articles addressed to the user are stored in these storage boxes, therefore, the user is able to retrieve the articles easily by entering the authentication information only once.

According to the first embodiment of the present invention, the storage apparatus 10 is configured to allow a common use box 163 in “unused” status to be unlocked even if authentication information is not entered. When the worker, etc., who intends to store an article addressed to the user cannot store the article in the dedicated box 162 because of having no authentication information or not knowing the authentication information, therefore, the worker can store the article in the common use box 163. This makes the worker's work more efficient and allows the user to efficiently receive an article addressed to the user.

According to the first embodiment of the present invention, the storage apparatus 10 unlocks the common use box 163 after closing and locking the mailbox 161 and the dedicated box 162. As a result, even if the common use box 163 is located distant from the mailbox 161 and the dedicated box 162 in the storage apparatus 10, a case where an article is taken out of the common use box 163 by a third party can be prevented.

It is therefore possible to freely design and provide common use boxes 163 in various locations in the storage apparatus 10 according to the structure and characteristics of each residential/use facility or the attributes of users who use the common use boxes 163.

### Second Embodiment

### (Outline of Second Embodiment)

According to the above first embodiment of the present invention, the dedicated box 162 is the box in which a worker stores deliveries, parcels, etc., too large to be thrown into the throw-in port of the mailbox 161 and such deliveries, parcels, etc., are kept temporarily until a user retrieves them.

According to a second embodiment of the present invention, the user can use the dedicated box 162 not only for the above-mentioned purpose of storing deliveries but also for the purpose of keeping the user's belongings, etc., in the same manner as a warehouse or trunk room does. These two patters of use of the dedicated box 162 can be switched by a setting operation.

Hereinafter, in the second embodiment, the dedicated box 162 used for the purpose of temporarily storing deliveries, etc., as in the first embodiment will be referred to as “home-delivery box”.

The dedicated box 162 used as a warehouse or trunk room, on the other hand, will be referred to as “trunk box”.

Hereinafter, description will be made on the assumption that, unless specified otherwise, the configuration and operation of the storage system according to the second embodiment is the same as that of the storage system according to the first embodiment.

### (Configuration of Second Embodiment)

### [1] Overall Configuration of Storage System

As shown in FIG. 1, the storage system according to the second embodiment of the present invention includes the storage apparatus 10, the management server 20, the user terminal 30, the authentication media 41 and 42, and the network 100, as the storage system according to the first embodiment of the present invention does.

### [2] Configuration of Storage Apparatus 10

### (1) Outline of Storage Apparatus 10

The storage apparatus 10 is a storage apparatus that includes a plurality of lockable storage boxes and that temporarily stores articles addressed to a user in the storage boxes. The storage apparatus 10 is installed in, for example, a common area (entrance) of a residential/use facility.

As shown in FIG. 3, the storage apparatus 10 according to the second embodiment includes the control unit 11, the information storage unit 12, the communication unit 13, the display unit 14, the information input unit 15, and the storage unit 16, as the storage apparatus 10 according to the first embodiment does.

### (2) Configuration of Storage Unit 16

As in the first embodiment, the storage unit 16 has three types of storage boxes: the mailbox 161, the dedicated box 162, and the common use box 163.

The mailbox 161 and the common use box 163 are the same as those of the first embodiment and therefore will be omitted in further description.

According to this embodiment, setting on unlocking of the dedicated box 162 (setting for determining whether the dedicated box 162 is to be used as a trunk box or home-delivery box) can be made by the user of the dedicated box 162.

For example, when, in a condominium, two users A and B reside in a dwelling unit with a room number “101” and two users C and D reside in a dwelling unit with a room number “102”, unlock setting on a dedicated box 162 allocated to the dwelling unit with the room number “101” can be made using authentication information assigned to the users A and B, and cannot be made using authentication information assigned to the users C and D.

When the dedicated box 162 is set as “storage allowed” in the storage box DB 122, which will be described later, the dedicated box 162 is allowed to be unlocked using authentication information on the user of the dedicated box 162 and also to be unlocked using authentication information on a worker (from, for example, a shipping carrier, etc.) who is an non-user individual.

In this case, the dedicated box 162 can be used as a “home-delivery box” in which a delivery to the user is stored temporarily.

Articles stored in the dedicated box 162 used as the home-delivery box include deliveries and other various articles, such as dry-cleaned clothes and goods delivered from stores.

The user is also allowed to store a cloth to be dry-cleaned in the storage apparatus 10, as a delivery. In such a case, the user stores the cloth not in the dedicated box 162 but in the common use box 163. This prevents a case where a worker, etc., from a dry-cleaning shop mistakes an article stored in the dedicated box 162 for a cloth to be dry-cleaned and takes the article out of the dedicated box 162.

When the dedicated box 162 is set as “storage prohibited” in the storage box DB 122, which will be described later, the dedicated box 162 is allowed to be unlocked using only the authentication information on the user of the dedicated box 162 and is not allowed to be unlocked using authentication information on a third party to the user, such as a worker from a shipping carrier, etc.

In this case, the worker is not allowed to store a delivery, etc., to the user in the dedicated box 162.

In this manner, when unlocking of the dedicated box 162 by third parties including the worker is not allowed, the dedicated box 162 can be used as a “trunk box” in which the user's belongings are stored.

The trunk box refers to a storage box in which the user's articles are stored. For example, if an article that is rarely used in the dwelling unit but is used at the entrance, etc., in which the storage apparatus 10 is installed, or carried outside the residential/use facility (condominium, etc.) in many cases is stored in the dedicated box 162, it saves the user trouble of carrying the article back to the dwelling unit every time the user finishes using the article. Articles stored in such a dedicated box 162 include, for example, a bicycle tier inflator and a set of car cleaning tools.

Even if an article is already stored in the dedicated box 162, another article can be additionally stored so long as an enough storage space remains.

For example, when the dedicated box 162 is set as “storage allowed” and can be used as a home-delivery box, even if a delivery is already stored in the dedicated box 162, the worker is allowed to unlock the dedicated box 162 and store an additional delivery therein.

For example, when the dedicated box 162 is set as “storage prohibited” and can be used as a trunk box, on the other hand, even if an article is already stored in the dedicated box 162, the user is allowed to unlock the dedicated box 162 and store an additional article therein.

### (3) Configuration of Information Storage Unit 12

As shown in FIG. 5, the information storage unit 12 of the storage apparatus 10 according to the second embodiment of the present invention includes the user DB 121, the storage box DB 122, and the worker DB 123, as the storage apparatus 10 according to the first embodiment of the present invention does.

The user DB 121, in the same manner as in the first embodiment, associates common authentication information for unlocking the mailbox 161 and dedicated box 162, which are allocated to the individual ownership space, and the common use box 163 storing an article addressed to the user, with each user ID to manage the authentication information.

In addition, according to this embodiment, the user can make setting on unlocking of the dedicated box 162, using the authentication information.

Specifically, as the mailbox 161 allocated to a certain individual ownership space, the dedicated box 162 allocated to the individual ownership space, and the common use box 163 storing an article addressed to the user residing in or using the individual ownership space can all be unlocked using common authentication information, whether the dedicated box 162 is to be used as a trunk box or as a home-delivery box can be determined using the common authentication information.

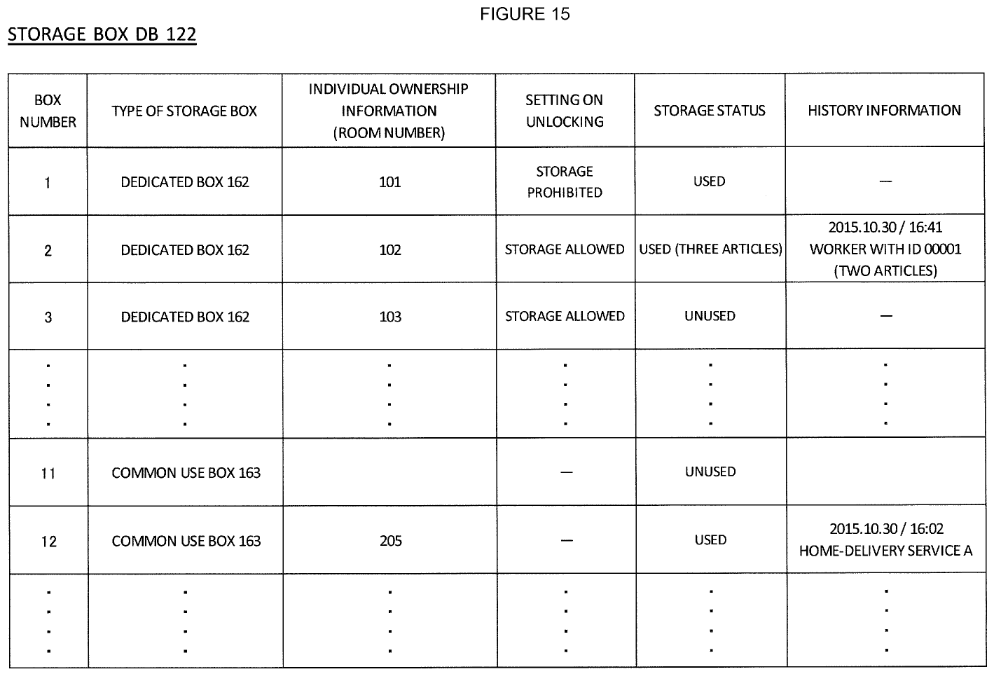

FIG. 15 is a diagram showing an example of a data configuration of the storage box DB 122 according to the second embodiment of the present invention.

In the example of FIG. 15, the storage box DB 122 associates a box number indicating each storage box with the type of a storage box (one of the mailbox 161, the dedicated box 162, and the common use box 163), with individual ownership space information (room number) for identifying a user's individual ownership space for the case of a storage box used exclusively by the user (mailbox 161 and dedicated box 162), with individual ownership space information (room number) on a user to whom a stored article is addressed for the case of the common use box 163, with details of unlocking setting on each dedicated box 162 (the dedicated box 162 can be unlocked only by the user or by the user and worker), with article storage status (“used” or “unused”, the number of stored articles when “used” status is specified), with history information indicating history of storage/retrieval of articles (information of a time at which an article has been stored in a storage box and of a person who has stored the article), and with an ID for a worker or group allowed to carry out unlocking for the case of the dedicated box 162 or the common use box 163, to manage these pieces of information.

### [3] Configuration of Management Server 20

The management server 20 is an information processing device that manages user information and the status of storage of articles addressed to the user in the storage apparatus 10. The management server 20 is installed inside or outside the residential/use facility.

As shown in FIG. 9, the management server 20 according to the second embodiment of the present invention includes the control unit 21, the information storage unit 22, and the communication unit 23.

### [4] Configuration of User Terminal 30

As shown in FIG. 11, the user terminal 30 according to the second embodiment of the present invention includes the control unit 31, the information storage unit 32, the communication unit 33, the display unit 34, and the information input unit 35.

### [5] Configuration of Authentication Media 41 and 42

In the same manner as in the first embodiment, the authentication medium 41 the user carries has recorded thereon user authentication information set for the user or the user's dwelling unit.

By entering the authentication information in the storage apparatus 10, using the authentication medium 41, the user is able to unlock the mailbox 161 and dedicated box 162 allocated to the user (user's dwelling unit) and also to unlock the common use box 163 storing an article addressed to the user.

Further, the user can make setting on unlocking of the user's dedicated box 162, using authentication information for unlocking the storage boxes 161 to 163 that is recorded on the authentication medium 41. Specifically, by entering the authentication information for unlocking in the storage apparatus 10, the user is able to determine whether the user's dedicated box 162 is to be set as a box that can be unlocked by the user only, that is, to be used as a trunk box, or set as a box that can be unlocked by both the user an worker, that is, to be used as a home-delivery box.

The storage box DB 122 manages information on the above setting on unlocking of the dedicated box 162.

The configuration of the authentication medium 42 the worker carries is the same as that of the worker's authentication medium 42 in the first embodiment.

### (Operations According to Second Embodiment)

### (1) Operations for Setting on Unlocking of Dedicated Box 162

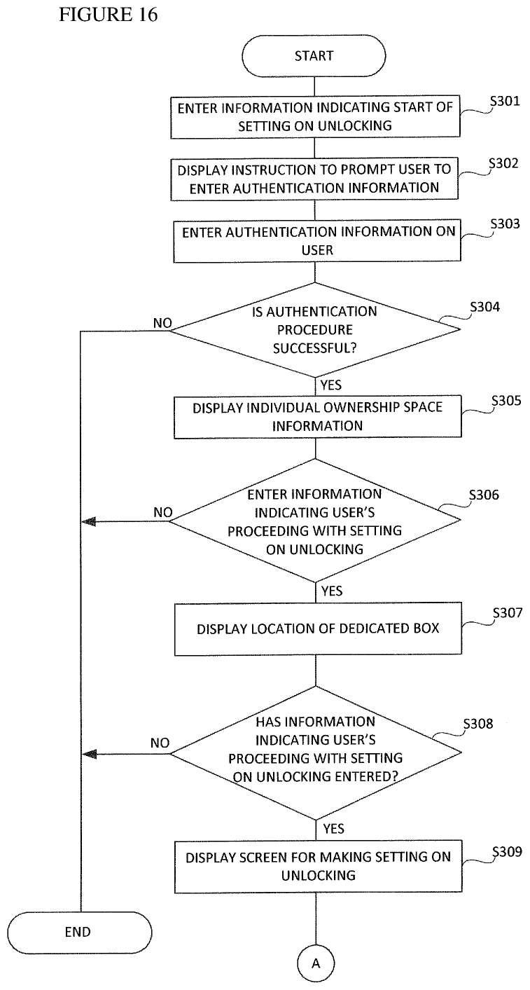

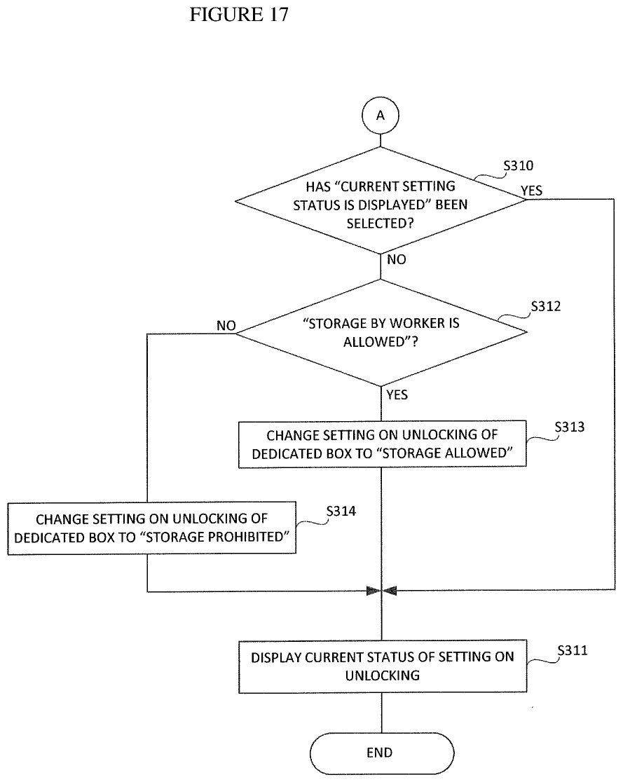

FIGS. 16 and 17 are flowcharts of flows of operations that are carried out by the storage apparatus 10 when setting is made on unlocking of the dedicated box 162, according to the second embodiment of the present invention.

Hereinafter, operations carried out by the storage apparatus 10 when the user makes setting on unlocking of the dedicated box 162 allocated to the user will be described, referring to FIGS. 16 and 17.

The user visits the location where the storage box 10 is installed in order to make setting on unlocking of the user's dedicated box 162.

The user then operates the information input unit 15 of the storage apparatus 10 to enter information indicating the start of setting on unlocking of the dedicated box 162 (step S301).

In response, the display unit 14 of the storage apparatus 10 displays a screen showing an instruction to prompt the user to enter authentication information (step S302).

The user then enters authentication information on the user by moving the authentication medium 41 closer to the information input unit 15 or punching keys of the information input unit 15 (step S303).

In response, the control unit 11 refers to the user DB 121 to compare authentication information recorded in the user DB 121 with the entered authentication information to check both pieces of authentication information against each other to authenticate the user (step S304).

When determining that the above authentication procedure has failed (step S304: No), the control unit 11 prohibits setting on unlocking of the dedicated box 162 and ends the operations.

When determining that the above authentication procedure is successful (step S304: Yes), on the other hand, the control unit 11 extracts individual ownership space information (room number) associated with the entered authentication information, from the user DB 121 and causes the display unit 14 to display the extracted individual ownership space information (step S305).

The user checks the displayed individual ownership space information (room number), and when finding that it matches the room number of the user's dwelling unit, enters information indicating the user's proceeding with setting on unlocking of the dedicated box 162, using the information input unit 15 (step S306).

When determining that the information indicating the user's proceeding with setting on unlocking of the dedicated box 162 has been entered (step S306: Yes), the control unit 11 refers to the storage box DB 122, extracts the box number associated with the above extracted individual ownership space information (room number), thereby identifies the user's dedicated box 162, and causes the display unit 14 to display the location of the user's dedicated box 162 (step S307).

The user checks the displayed location of the user's dedicated box 162 and when finding that the displayed location matches the actual location of the user's dedicated box 162, enters information indicating the user's proceeding with setting on unlocking of the dedicated box 162, using the information input unit 15 (step S308).

When determining that the information indicating the user's proceeding with setting on unlocking of the dedicated box 162 has been entered (step S308: Yes), the control unit 11 causes the display unit 14 to display on-screen information for determining whether or not to allow the worker to unlock the user's dedicated box 162, that is, allow the worker to store a delivery in the user's dedicated box 162 (step S309).

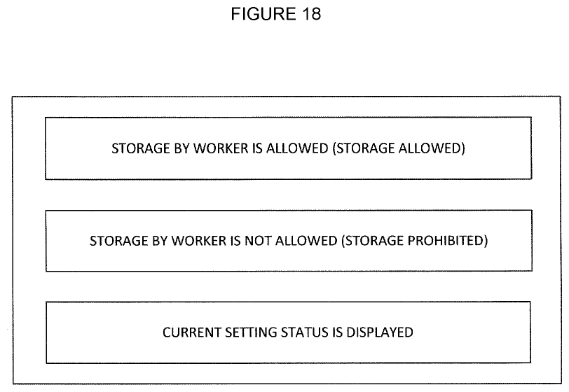

FIG. 18 is a diagram showing an example of on-screen information for determining whether or not to allow a worker to store a delivery, according to the second embodiment of the present invention.

In the example of FIG. 18, displayed on-screen information indicates three options: “storage by worker is allowed (storage allowed)”, “storage by worker is not allowed (storage prohibited)”, and “current setting status is displayed”.

After the on-screen information is displayed, when determining that “current setting status is displayed” has been selected out of the three options (step S310: Yes), the control unit 11 refers to the storage box DB 122, extracts the details of current setting on unlocking of the dedicated box 162, and causes the display unit 14 to display the extracted details of current setting on unlocking of the dedicated box 162 (step S311).

When determining that “current setting status is displayed” has not been selected out of the three options (step S310: No), the control unit 11 determines whether “storage by worker is allowed (storage allowed)” has been selected (step S312).

When determining that “storage by worker is allowed (storage allowed)” has been selected (step S312: Yes), the control unit 11 refers to the current “setting on unlocking” in the storage box DB 122. When “setting on unlocking” is “storage allowed”, the control unit 11 leaves “storage allowed” as it is, but when “setting on unlocking” is “storage prohibited”, the control unit 11 rewrites it to “storage allowed” (step S313), and then causes the display unit 14 to display “storage allowed” as the current status of setting on unlocking (step S311).

When determining that “storage by worker is allowed (storage allowed)” has not been selected, that is, “storage by worker is not allowed (storage prohibited)” has been selected (step S312: No), the control unit 11 refers to the current “setting on unlocking” in the storage box DB 122. When “setting on unlocking” is “storage prohibited”, the control unit 11 leaves “storage prohibited” as it is, but when “setting on unlocking” is “storage allowed”, the control unit 11 rewrites it to “storage prohibited” (step S314), and then causes the display unit 14 to display “storage prohibited” as the current status of setting on unlocking (step S311).

This is the end of the operations for setting on unlocking.

When the dedicated box 162 is set in “storage allowed” status by the operations for setting on unlocking, the worker is allowed to store an article in the dedicated box 162, which means that the dedicated box 162 can be used as a home-delivery box.

When the dedicated box 162 is set in “storage prohibited” status by the operations for setting on unlocking, the worker is not allowed to store an article in the dedicated box 162, which means that the dedicated box 162 can be used as a trunk box.

(2) Operations Carried Out when Worker Store Article

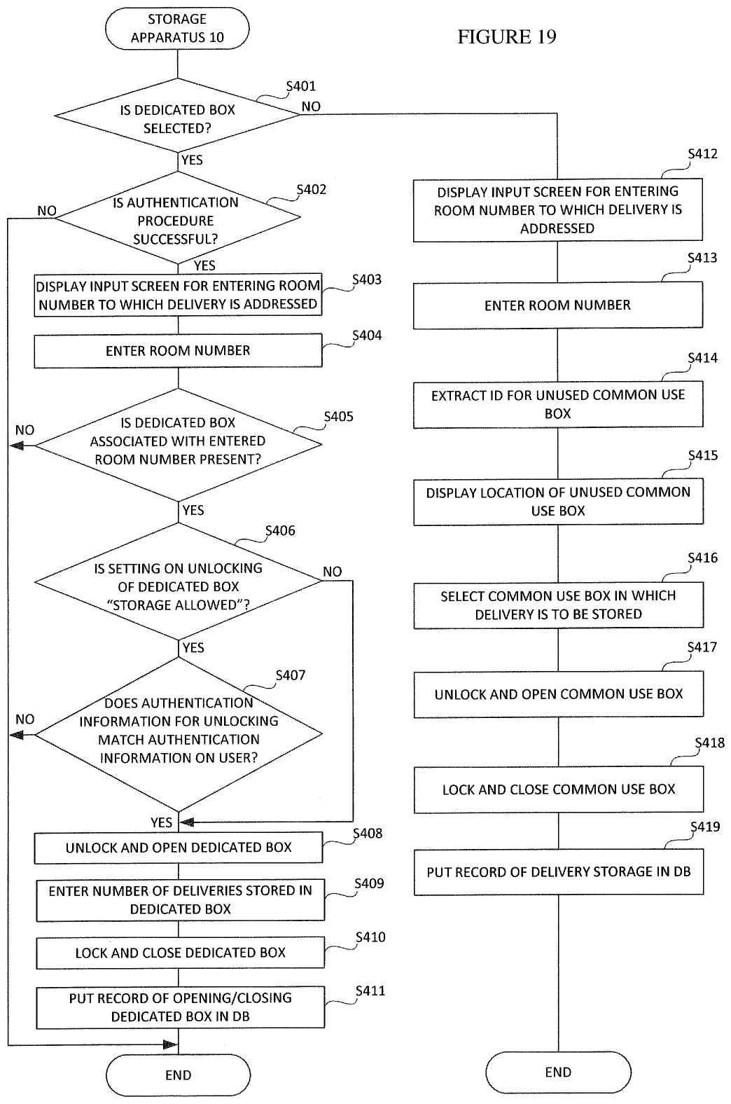

FIG. 19 is a flowchart of a flow of operations that are carried out by the storage apparatus 10 when a worker from a shipping carrier, etc., stores an article in the storage apparatus 10, according to the second embodiment of the present invention.

Operations carried out by the storage apparatus 10 when a worker stores an article, which is addressed to a user, in a storage box will hereinafter be described, referring to FIG. 19.

It is assumed in this example that the article the worker intends to store is a delivery, etc., and is stored in either the dedicated box 162 or the common use box 163.

The worker carrying a delivery to the user visits a location where the storage apparatus 10 is installed, such as the entrance of a condominium.

When the worker selects “article storage” on the information input unit 15 of the storage apparatus 10, as the purpose of use of the storage apparatus 10, icons for selecting “dedicated box” and “common use box” are displayed on the display unit 14.

The worker selects a storage box in which a delivery is to be stored, from the “dedicated box” and “common use box” icons displayed on the display unit 14 (step S401).

When having selected the dedicated box 162 (step S401: Yes), the worker holds the authentication medium 42 up over the information input unit 15 for the authentication procedure. In response to this, the information input unit 15 of the storage apparatus 10 reads a worker ID and authentication information written on the authentication medium 42. The control unit 11 then refers to the storage box DB 122 and the worker DB 123 to determine whether the read worker ID and authentication information are associated with each other and stored in both DBs and also determine whether the worker identified with the worker ID is allowed to unlock the dedicated box 162 (step S402).

When the worker ID and authentication information are not associated with each other in both DBs or when the worker ID and authentication information are associated but the worker is not allowed to unlock the dedicated box 162 (step S402: No), the control unit 11 determines that the authentication procedure has failed, and ends the operations.

When the worker ID and authentication information are associated with each other in both DBs and the worker is allowed to unlock the dedicated box 162 (step S402: Yes), the control unit 11 determines that the authentication procedure is successful, and causes the display unit 14 to display an input screen for inputting a room number (individual ownership space) to which the delivery is addressed (step S403).

Subsequently, the worker checks a slip, etc., attached to the delivery and enters the room number, to which the delivery is addressed, in an entry space on the room number input screen displayed by the display unit 14, using the information input unit 15 (step S404).

In response to this, the control unit 11 of the storage apparatus 10 refers to the storage box DB 122 to determine whether the dedicated box 162 associated with the entered room number is present (step S405).

When finding on dedicated box 162 associated with the entered room number, that is, when determining that the user identified with the room number does not use the dedicated box 162 (step S405: No), the control unit 11 ends the operations.

Afterward, the worker makes another selection to select “common use box” at step S401 (step S401). Operations to follow after selection of “common use box” will be described in detail later.

When finding a dedicated box 162 associated with the entered room number (step S405: Yes), the control unit 11 refers to the storage box DB 122 and determines whether “setting on unlocking” of the dedicated box 162 associated with the room number is “storage allowed” (step S406).

When determining that “setting on unlocking” of the dedicated box 162 associated with the room number is “storage prohibited”, that is, storing an article in the dedicated box 162 by a third party to the user identified with the room number is prohibited (step S406: No), the control unit 11 refers to the user DB 121 and determines whether the authentication information entered at step S402 matches user authentication information associated with the room number corresponding to the dedicated box 162 (step S407).

When determining that the authentication information entered at step S402 does not match the user authentication information associated with the room number corresponding to the dedicated box 162 (step S407: No), the control unit 11 is able to conclude that the dedicated box 162 is not allowed to be used by a third party to the user and that a person who currently intends to use the dedicated box 162 is the third party. The control unit 11 thus does not allow the third party, i.e., worker to unlock the dedicated box 162 and keeps the dedicated box 162 locked. At this point, the control unit 11 ends the operations.

Afterward, the worker makes another selection to select “common use box” at step S401 (step S401). Operations to follow selection of “common use box” will be described in detail later.

When a person who intends to store an article in the dedicated box 162 is the user of the dedicated box 162, which is a situation different from the situation described in this example, the control unit 11 determines that the authentication information entered at step S402 matches the user authentication information associated with the room number corresponding to the dedicated box 162 (step S407: Yes), and therefore allows the user to unlock and open the dedicated box 162 (step S408).

Now step S406 will be described further.

When determining that “setting on unlocking” of the dedicated box 162 associated with the room number is “storage allowed”, that is, storing an article in the dedicated box 162 by a third party to the user identified with the room number is allowed (step S406: Yes), the control unit 11 allows the worker to unlock and open the dedicated box 162 (step S408).

The worker checks the storage status of the opened dedicated box 162, and places deliveries, which the worker has brought in as this round of delivery, in an empty space in the dedicated box 162 such that the amount of deliveries corresponds to the size of the space. The worker then enters the number of the stored deliveries, using the information input unit 15 (step S409).

Subsequently, the worker closes and locks the dedicated box 162 (step S410).

At this time, the control unit 11 of the storage apparatus 10 puts a record of the worker's unlocking and opening the dedicated box 162 for the purpose of storing the delivery (or deliveries), in the storage box DB 122 (step S411).

Specifically, the control unit 11 records the worker ID entered at step S402, information on the time of delivery, and the number of the stored deliveries, in the corresponding history information space in the field of the dedicated box 162 in the storage box DB 122.

When an article is not stored in the dedicated box 162 before this round of delivery, in which case “unused” is entered in the corresponding storage status space in the field of the dedicated box 162 in the storage box DB 122, “unused” is rewritten to “used”. When an article is already stored in the dedicated box 162, on the other hand, “used” entered in the corresponding storage status space is maintained.

Further, in the storage status space, the number of deliveries stored in this round of delivery is added to the total of deliveries stored in the dedicated box 162 before this round of delivery to enter the current number of deliveries stored.

This is the end of the operations.

When the dedicated box 162 has no extra space to accommodate the delivery, the worker does not store the delivery, and enters “0” as the number of stored deliveries or does not enter any number at all (step S409), and then closes and locks the dedicated box 162 (step S410).

At this time, as in the above case of storing the delivery, the control unit 11 puts a record of the worker's unlocking and opening the dedicated box 162 for the purpose of storing the delivery (or deliveries), in the storage box DB 122 (step S411).

Specifically, the control unit 11 records the worker ID entered at step S402 and information on the time of opening the dedicated box 162, in the corresponding history information space in the field of the dedicated box 162 in the storage box DB 122.

The operations carried when storage in the dedicated box 162 is selected at step S401 have been described above. Operations carried out when storage in the common use box 163 is selected will hereinafter be described.

When the worker selects the common use box 163, in which a delivery is to be stored, from displayed icons of “dedicated box” and “common use box” displayed on the display unit 14, using the information input unit 15 of the storage apparatus 10 (step S401: No), the display unit 14 displays the room number input screen (step S412).

Subsequently, on the room number input screen, the worker enters the user's room number to which the delivery is addressed, using the information input unit 15 (step S413).

In place of the room number, the worker may enter other type of information if the information identifies the user to whom the delivery is addressed.

The worker may also enter information identifying the worker, using the information input unit 15. For example, the names of traders (shipping carrier, etc.) one of which the worker works for, such as “shipping carrier A”, “shipping carrier B”, “dry-cleaning shop C”, and “store D”, are listed on the display unit 14, and the worker may select the name of a trader (shipping carrier, etc.) the worker works for out of these names of traders to enter information identifying the worker, using the information input unit 15.

Subsequently, the control unit 11 refers to the storage box DB 122 to identify an unused common use box (or unused use common boxes) 163 and extract the storage box ID for the common use box 163 (step S414).

Based on the extracted storage box ID, the control unit 11 causes the display unit 14 to display the location, etc., of the unused common use box 163 (step S415).

Subsequently, the worker selects a desired common use box 163 from one or more unused common use boxes 163 displayed on the display unit 14, using the information input unit 15 (step S416).

The control unit 11 allows the worker to unlock and open the selected common use box 163 (step S417).

The worker stores the delivery in the opened common use box 163, and closes and locks the common use box 163 (step S418).

The control unit 11 then puts a record of the worker's storing the delivery in the common use box 163, in the storage box DB 122 (step S419).

Specifically, the room number entered at step S411 or the user ID associated therewith is recorded in the corresponding individual ownership space information (room number) space in the field of the common use box 163 in the storage box DB 122.

In addition, information of the time of storage and the name of a trader the worker works for (if it has been entered) are recorded in the corresponding history information space in the field of the common use box 163 in the storage box DB 122.

The entry in the corresponding storage status space in the field of the common use box 163 in the storage box DB 122 is written from “unused” to “used”.

Afterward, the user visits the location where the storage apparatus 10 is installed, and causes the storage apparatus 10 to read authentication information from the user's authentication medium 41, by operating the information input unit 15. Based on the authentication information read from the authentication medium 41, the storage apparatus 10 carries out the authentication procedure. If the authentication procedure is successful, the storage apparatus 10 unlocks and opens the common use box 163. This is the end of the whole processes.

When the worker closes and locks the storage box without storing a delivery therein, as in the above described case, the display unit 14 prompts the worker to store the delivery in an unused common use box 163 by displaying its location, etc. The control unit 11 may recognize the fact that the storage box is closed without storing the delivery therein, by the following processes.

For example, after closing and locking the storage box without storing the delivery therein, the worker enters information indicating that fact, using the information input unit 15 (pressing a given button, etc.). The control unit 11 thus recognizes the fact.

In another process, the weight scale of the article detecting unit 1615 provided in the dedicated box 162 or the common use box 163 may measure the weight of the delivery in the box before opening of the box and the same after closing of the box and output the resulting measurements to the control unit 11. In this case, the control unit 11 compares the weight information input by the weight scale of the article detecting unit 1615 before opening of the box with the weight information input by the same after closing of the box, and when the weight measured after closing of the box does not indicate an increase from the weight measured before opening of the box, determines that the worker has closed and locked the dedicated box 162 or the common use box 163 without storing the delivery therein.

Still another process may also possible, according to which the article detecting unit 1615 senses a change in the storage status in the dedicated box 162 or the common use box 163, using the function as the infrared sensor.

As described above, the user can make setting on the dedicated box 162 of the storage apparatus 10 in such a way as to allow the use of the dedicated box 162 as a box for storing a delivery therein. Even when all the common use boxes are being used, therefore, the user can receive a delivery certainly.

Furthermore, the user can change setting on the dedicated box 162 of the storage apparatus 10 in such a way as to prohibit the use of the dedicated box 162 as a box for storing a delivery therein. In such a case, the dedicated box 162 can be used as a so-called trunk box in which the user's belongings are stored.

When the worker does not have authentication information that allows the worker to unlock the dedicated box 162, the worker is allowed to store an article addressed to the user in an “unused” common use box 163, and is therefore able to perform smooth delivery work.

(3) Operations Carried Out when User Retrieve Article

After the worker stores an article addressed to the user in a storage box of the storage apparatus 10, as in the above case, the user having noticed that fact visits the location where the storage apparatus 10 is installed and retrieves the article addressed to the user from the storage box.

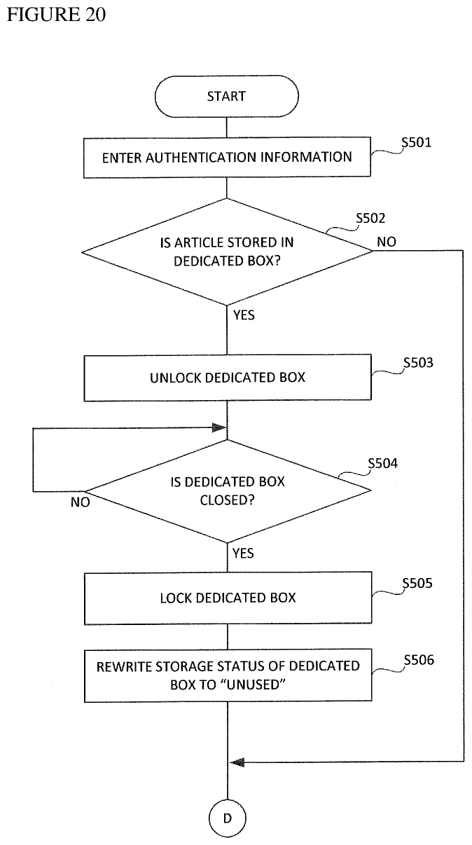

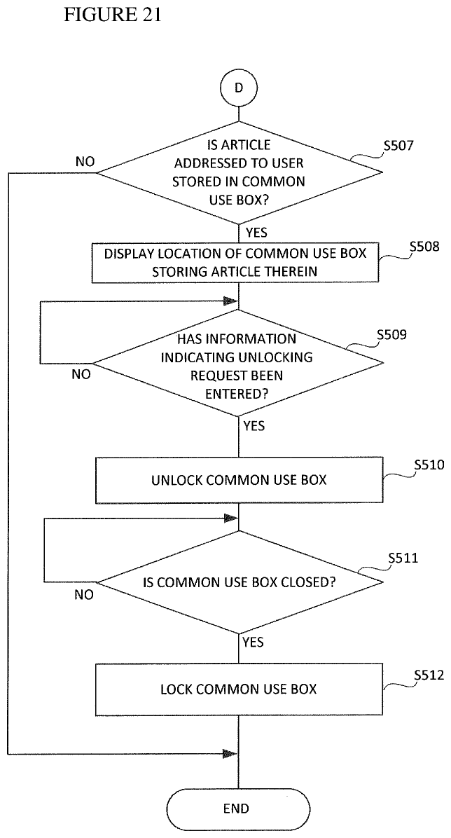

FIGS. 20 and 21 are flowcharts of flows of operations that are carried out by the storage apparatus 10 when a user retrieves an article from the storage apparatus 10, according to the second embodiment of the present invention.

Description will hereinafter be made, referring to FIGS. 20 and 21.

A user visits the entrance of a condominium in which the storage apparatus 10 storing an article addressed to the user is installed.

Operating the information input unit 15, the user enters authentication information on the user (password, etc.), together with information indicating an article retrieval request (step S501).

Methods of entering the authentication information include entering the authentication formation, such as a password, using numerical keys, etc., included in the information input unit 15, and causing the information input unit 15 to read the authentication information written on an information recording medium, such as an IC card, using the short-range radio communication function, such as infrared communication, or the card reader function.

The control unit 11 refers to the user DB 121 to identify the user corresponding to the above read authentication information, and refers to the storage box DB 122 to determine whether the article is stored in the user's dedicated box 162 (step S502).

When determining that the article is not stored in the user's dedicated box 162 (step S502: No), the control unit 11 executes a process of step S507, which will be described later.

When determining that the article is stored in the user's dedicated box 162 at step S502 (step S502: Yes), the control unit 11 allows the user to unlock the dedicated box 162 (step S503).

The user opens the dedicated box 162 that has been unlocked, takes out the articles address to the user, and closes the dedicated box 162.

When confirming that the dedicated box 162 has been closed (step S504: Yes), the control unit 11 locks the dedicated box 162 (step S505), and writes a record of having retrieved the article from the dedicated box 162 to the storage box DB 122 to reflect the record therein (step S506).

Specifically, the control unit 11 changes an entry of the storage status of the dedicated box 162 in the storage box DB 122, from “used” to “unused”.

Subsequently, the control unit 11 refers to the storage box DB 122 to determine whether a common use box 163 storing therein an article addressed to the user is present (step S507).

In other words, the control unit 11 determines whether a common use box 163 associated with the user's room number (individual dwelling space information) and indicated as “used” in the storage box DB 122 is present.

When determining that a common use box 163 storing therein an article addressed to the user is not present (step S507: No), the control unit 11 concludes that every article addressed to the user has been retrieved from the storage apparatus 10 and therefore ends the operations.

When determining that a common use box 163 storing therein an article addressed to the user is present (step S507: Yes), the control unit 11 causes the display unit 14 to display the location of the common use box 163 (step S508).

When taking the article out of the common use box 163, the user operates the information input unit 15 (presses a button, etc.) to enter information indicating a request for unlocking the common use box 163 (step S509: Yes).

When determining that the information indicating a request for unlocking the common use box 163 has been entered (step S509: Yes), the control unit 11 allows the user to unlock the common use box 163 (step S510).

The user then opens the unlocked common use box 163, takes the article address to the user out, and closes the common use box 163.

When confirming that the common use box 163 has been closed (step S511: Yes), the control unit 11 locks the common use box 163 (step S512) and ends the operations.

When the user has no intention to take the article address to the user out of the common use box 163, the user operates the information input unit 15 (presses a button, etc.) to enter information indicating the user having no intention to take the article out (step S509: No).

At this step, when a given time has elapsed from the point of time at which the display unit 14 displays the location of the common use box 163 as the information indicating a request for unlocking the common use box 163 is not entered, the control unit 11 may determine that information indicating the user having no intention to take the article out of the common use box 163 has been entered.

When determining that the information indicating the user having no intention to take the article out of the common use box 163 has been entered (step S509: No), the control unit 11 ends the operations without unlocking the common use box 163.

As described above, when an article addressed to the user is stored in the dedicated box 162 or the common use box 163, the storage apparatus 10 allows the user to unlock each of these storage boxes using common authentication information. This allows the user to easily retrieve the article addressed to the user by a simple operation.

### (Summary of Second Embodiment)

As described above, according to the storage apparatus 10 of the second embodiment of the present invention, the user is able to make setting to allow or prohibit storage of a delivery in the dedicated box 162 serving as a storage box used exclusively by the user or a group to which the user belongs (dwelling unit, etc.). The user, therefore, can change a pattern of use of the dedicated box 162 according to the intended purpose of use of the dedicated box 162, thus being able to use the dedicated box 162 in a pattern that meets the user's need in a given situation.

For example, when the user makes setting on the dedicated box 162 of the storage box 10 in such a way as to allow storage of a delivery in the dedicated box 162, even if the common use boxes 163 are all occupied with deliveries stored therein, the user is able to store a delivery in the dedicated box 162. This allows the user to certainly receive a delivery to the user.

When the user makes setting on the dedicated box 162 of the storage box 10 in such a way as to prohibit storage of a delivery in the dedicated box 162, on the other hand, the user can use the dedicated box 162 as a trunk box in which the user's articles are stored. The user, therefore, can keep those articles in the entrance, etc., where the storage apparatus 10 is installed. This saves the user such trouble that the user bothers to carry the articles out of the user's individual ownership space (dwelling unit) every time the articles are needed and after using the articles, bring them back.

According to the second embodiment of the present invention, once authentication information on the user is entered and the authentication procedure is successful, the storage apparatus 10 allows all of the following processes: unlocking of the user's dedicated box 162, unlocking of the common use box 163 storing a delivery to the user, and setting on authentication information with which the user's dedicated box 162 can be unlocked. The user is thus required to manage the single piece of authentication information only. This allows simplification of unlocking and authentication information setting procedures.

According to the second embodiment of the present invention, the storage apparatus 10 unlocks the dedicated box 162 and the common use box 163, based on common user authentication information. When articles addressed to the user are stored in these storage boxes, therefore, the user is able to retrieve the articles easily by entering the authentication information only once.

According to the second embodiment of the present invention, the storage apparatus 10 unlocks the common use box 163 after closing and locking the dedicated box 162. As a result, even if the common use box 163 is located distant from the dedicated box 162 in the storage apparatus 10, a case where an article is taken out of the common use box 163 by a third party can be prevented.

It is therefore possible to freely design and provide common use boxes 163 in various locations in the storage apparatus 10 according to the structure and characteristics of each residential/use facility or the attributes of users who use the common use boxes 163.

### <Summary of Embodiments>

As described above, the storage apparatus 10 according to the first and second embodiments of the present invention includes the mailbox 161 having the throw-in port, the mailbox 161 storing articles, such as mails, thrown into the mailbox 161 through the throw-in port, the dedicated box 162 allocated to each individual ownership space (dwelling unit), the dedicated box 162 storing articles, such as deliveries, and the common use box 163 that stores articles, such as deliveries, as the dedicated box 162 does, and that can be used in common by individual users residing in individual ownership spaces (dwelling units). The storage apparatus 10, therefore, can store therein various types of articles addressed to the user.

In the storage apparatus 10, the mailbox 161 and the dedicated box 162 are located adjacent or close to each other. When articles addressed to the same user (individual ownership space) are stored in both storage boxes 161 and 162, therefore, the user is able to retrieve the articles all together, which offers a security advantage, thus allowing the user to retrieve the articles in a safe condition.

As described above, according to the storage apparatus 10 of the second embodiment of the present invention, the user is able to make setting to allow or prohibit storage of a delivery in the dedicated box 162 serving as a storage box used exclusively by the user or a group to which the user belongs (dwelling unit, etc.). The user, therefore, can change a pattern of use of the dedicated box 162 according to the intended purpose of use of the dedicated box 162 in a given situation where the user expects to receive a delivery or, contrary to that, does not expect a delivery, thus being able to use the dedicated box 162 in a pattern that meets the user's need in a given situation.

The storage apparatus 10, the management server 20, and the user terminal 30 that have been described above are basically configured by programs loaded onto the CPU and memory. These apparatuses or server, however, may also be configured by combining given hardware and software other than those programs. A high degree of freedom in designing these apparatuses or server is readily understandable to those who skilled in art.

When the storage apparatus 10, the management server 20, and the user terminal 30 are configured as a group of software modules, programs for creating these software modules may be recorded on a recording medium, such as an optical recording medium, a magnetic recording medium, a magneto-optic recording medium, and a semiconductor recording medium, and may be downloaded from the recording medium or may be downloaded from an external device connected to the apparatuses or server through a given network

As described above, an article stored in the dedicated box 162 or common use box 163 may be an article other than deliveries, such as a cloth to be dry-cleaned.

For example, the storage system can be used for a dry-cleaning service in which a resident in the condominium stores a cloth to be dry-cleaned in the common use box 163, and a worker from a dry-cleaning shop retrieves and carries the cloth to the shop, dry-cleans the cloth, and then puts the cleaned cloth back in the dedicated box 162 or common use box 163.

The resident, who is to receive the cleaned cloth, then takes the cleaned cloth delivered to the resident out of the storage apparatus 10.

In this manner, the storage system may be used as a system in which the user acts as a person who stores an article and the worker acts as a person who retrieves an article.

Operations carried out by the storage apparatus 10 in a case where the user acts as a person who stores an article and the worker acts as a person who retrieves an article will be described briefly by taking an example in which the article is a cloth to be dry-cleaned.

Unless otherwise specified, however, the overall configuration is the same as in the case where the worker acts as a person who stores an article and the user acts as a person who retrieves an article.

For example, when a user, who is a resident in the condominium, stores a cloth in the common use box 163 of the storage apparatus 10 for the purpose of having the cloth dry-cleaned by a dry-cleaning shop, the user enters the user's room number (individual ownership information) and also enters information on the dry-cleaning shop, using the information input unit 15, to allow a worker from the dry-cleaning shop to unlock the common use box 163 so that the worker can retrieve the cloth.

The information on the dry-cleaning shop is entered, for example, such that the user presses a “cleaning request” button provided on the information input unit 15 or displayed on a touch panel (constructed by combining the display unit 14 and the information input unit 15 together) to enter the information.

In response, the control unit 11 writes the user's room number to the storage box DB 122 and also writes the ID for the dry-cleaning shop, the ID being associated with the entered information on the shop, to the storage box DB 122 to enter the ID as an ID for a group allowed to unlock the common use box 163 in which the cloth is stored.

Afterward, when a worker who works for the dry-cleaning shop enters authentication information, using the information input unit 15 of the storage apparatus 10, information on the location, etc., of the common use box 163, the information including the ID for the dry-cleaning shop, is displayed on the display unit 14.

Subsequently, when the worker selects the displayed information on the storage box, using the information input unit 15, the common use box 163 indicated by the selected information is unlocked.

As described above, when, in the storage box DB 122, for example, an ID for a “dry-cleaning shop B” is associated with the common use box 163, only the worker who works for the “dry-cleaning shop B” is allowed to unlock the common use box 163, and workers who belong to (work for) other groups (e.g., other dry-cleaning shops, shipping carriers, etc.) are not allowed to unlock the common use box 163.

When the worker having the group ID associated with the common use box 163 unlocks the common use box 163, an item of “worker allowed to unlock”, which is associated with the unlocked common use box 163 in the storage box DB 122, is deleted.

As described above, when the user requests the worker to take out the user's cloth to be dry-cleaned or other articles (including deliveries), the user is allowed to store articles including a cloth to be dry-cleaned in the common use box 163 only.

In this manner, when the user stores an article for the purpose of requesting the worker to take out the article, the user enters the user's room number, etc., to allow the worker to recognize that the article is stored by the user. When “article storage” is selected, the control unit 11 of the storage apparatus 10 prevents the user from storing an article in the dedicated box 162 and allows the user to unlock only the “unused” common use box 163. This prevents a case where the worker, who is supposed to take out an article stored by the user, mistakenly takes an article addressed to the user out of the dedicated box 162.

A user who resides in the condominium may store an article addressed to a different user in the same condominium, in the storage apparatus 10. The different user who is to receive the article then retrieves the article addressed to the different user from the storage apparatus 10.

In this manner, the storage system may be used as a system in which the user acts both as a person who stores an article and as a person who retrieve an article.

As described above, a business who offers a service of keeping articles may offers the service not only at condominiums but also at offices, commercial facilities, or public facilities or institutions. In this case, users are not limited to residents in condominiums.

According to the above embodiments, as an example, common authentication information is assigned to users who reside in or use the same individual ownership space and is managed in the user DB 121.

Such individual ownership spaces include dwelling units as mentioned in the above embodiments and also include, for example, office spaces, tenants, and lesson rooms.

It may also possible that common authentication information is assigned not only to a group of users who use or reside in a physically common space (individual ownership space) but also to a plurality of users who commonly belong to a given group but do not always use a physically common space, and is managed in the user DB 121. In this case, the mailbox 121 and the dedicate box 162 are used exclusively by the given group.

Examples of such a group include and not limited to a corporation, a section in a company, a chain store, school, club, and other organizations/institutions.

It is obvious that authentication information may be assigned to the user as personal authentication information so that the mailbox 161 and the dedicated box 162 are used exclusively by the user.

According to the second embodiment, common authentication information recorded on the authentication medium 41 for the user is used to unlock the dedicated box 162 and the common use box 163 and to make setting on unlocking of the dedicated box 162. However, different pieces of authentication information may be used for these processes of unlocking and making unlocking setting.

### EXPLANATION OF REFERENCE SIGNS

10 storage apparatus
11, 21, 31 control unit
12, 22, 32 information storage unit
12, 23, 33 communication unit
14, 34 display unit
15, 35 information input unit
16 storage unit
20 management server
30 user terminal
41, 42 authentication medium
100 network
121, 122 user DB
122, 222 storage box DB
123, 223 worker DB
161 mailbox
162 dedicated box
163 common use box
1611 storage chamber
1612 storage/retrieval opening
1613 door
1614 locking/unlocking unit
1615 article detecting unit
1617 hinge
1618 hook
1619 hook hole
19191c door opening/closing detecting unit

What is claimed is:

1. A storage apparatus having a plurality of lockable storage boxes for storing articles, the storage apparatus comprising:
a control unit that executes an authentication process for unlocking the storage boxes; and
the storage boxes including:
a mailbox serving as a dedicated storage box allocated to a user or the user's group, the mail box having a throw-in port that is an opening through which an article, such as a mail, is thrown in, and storing an article having been thrown into the mail box through the throw-in port;
a dedicated box serving as a dedicated storage box allocated to a user or the user's group, the dedicated box storing a delivery, etc.; and
a common use box serving as a storage box that are used in common by a user or the user's group and by others as well, the common use box storing a delivery, etc.

2. The storage apparatus according to claim 1, wherein
when common authentication information assigned to a user is entered, the control unit unlocks the mail box, the dedicated box, and the common use box in which an article addressed to the user or to another user included in the user' group is stored.

3. The storage apparatus according to claim 1, wherein
in a case where an article address to a user or to another user included in the user's group is stored in the dedicated box, the control unit unlocks the dedicated box and the mail box as well when authentication information is entered.

4. The storage apparatus according to claim 2, wherein
in a case where an article address to a user or to another user included in the user's group is stored in the dedicated box, the control unit unlocks the dedicated box and the mail box as well when authentication information is entered.

5. The storage apparatus according to claim 1, further comprising a display unit that displays information, wherein
in a case where an article address to a user or to another user included in the user's group is stored in the common use box, the control unit unlocks the mail box when authentication information is entered, and after the mailbox is locked, displays presence of the common use box in which the article addressed to the user or to another user included in the user's group is stored and prompts retrieval of the article.

6. The storage apparatus according to claim 2, further comprising a display unit that displays information, wherein
in a case where an article address to a user or to another user included in the user's group is stored in the common use box, the control unit unlocks the mail box when authentication information is entered, and after the mailbox is locked, displays presence of the common use box in which the article addressed to the user or to another user included in the user's group is stored and prompts retrieval of the article.

7. The storage apparatus according to claim 3, further comprising a display unit that displays information, wherein
in a case where an article address to a user or to another user included in the user's group is stored in the common use box, the control unit unlocks the mail box when authentication information is entered, and after the mailbox is locked, displays presence of the common use box in which the article addressed to the user or to another user included in the user's group is stored and prompts retrieval of the article.

8. The storage apparatus according to claim 4, further comprising a display unit that displays information, wherein
in a case where an article address to a user or to another user included in the user's group is stored in the common use box, the control unit unlocks the mail box when authentication information is entered, and after the mailbox is locked, displays presence of the common use box in which the article addressed to the user or to another user included in the user's group is stored and prompts retrieval of the article.

9. A storage apparatus having a plurality of lockable storage boxes for storing articles, wherein
the storage boxes include: a mailbox serving as a dedicated storage box allocated to a user or the user's group, the mail box having a throw-in port that is an opening through which an article, such as a mail, is thrown in, and storing an article having been thrown into the mail box through the throw-in port; and
a dedicated box serving as a dedicated storage box allocated to a user or the user's group, the dedicated box storing a delivery, etc., and wherein
the mailbox and the dedicated box are located adjacent or close to each other.

10. A storage apparatus having a lockable storage box that stores an article, the storage box being unlocked by entering given authentication information, wherein
the storage box is a dedicated box allocated to a specific user or a specific group made up of a plurality of users, and wherein
setting on unlocking of the dedicated box is made to determine whether the dedicated box is unlocked with only authentication information on the specific user or with the authentication information on the specific user as well as authentication information on a worker who stores or retrieves the specific user's article, thereby determine use of the dedicated box.

11. The storage apparatus according to claim 10, wherein
when authentication information identical with authentication information on a user allowed to unlock the dedicated box is entered, setting authentication information with which the dedicated box is unlocked is allowed.

12. The storage apparatus according to claim 10, wherein
when unlocking of the dedicated box is set such that the dedicated box is unlocked with authentication information on the user as well as authentication information on the worker, the dedicated box is used as a home-delivery box that temporarily keeps a delivery addressed to the user or a delivery stored in the dedicated box by the user.

13. The storage apparatus according to claim 11, wherein
when unlocking of the dedicated box is set such that the dedicated box is unlocked with authentication information on the user as well as authentication information on the worker, the dedicated box is used as a home-delivery box that temporarily keeps a delivery addressed to the user or a delivery stored in the dedicated box by the user.

14. The storage apparatus according to claim 10, wherein
when unlocking of the storage box is set such that the storage box is unlocked only with authentication information on the user, the storage box is used as a trunk box that keeps an article stored therein by the user.

15. The storage apparatus according to claim 11, wherein
when unlocking of the storage box is set such that the storage box is unlocked only with authentication information on the user, the storage box is used as a trunk box that keeps an article stored therein by the user.

16. The storage apparatus according to claim 14, wherein
the storage boxes include a dedicated box allocated to the specific user and a common use box used in common by a plurality of users, and when setting is made on the dedicated box allocated to the specific user such that the dedicated box is unlocked only with authentication information on the specific user, the worker is prompted to store a delivery in the common use box.

17. The storage apparatus according to claim 15, wherein
the storage boxes include a dedicated box allocated to the specific user and a common use box used in common by a plurality of users, and when setting is made on the dedicated box allocated to the specific user such that the dedicated box is unlocked only with authentication information on the specific user, the worker is prompted to store a delivery in the common use box.
